(19) United States
(12) Patent Application Publication
(10) Pub. No.: US 2024/0257444 A1
(43) Pub. Date: Aug. 1, 2024

(54) METHOD AND APPARATUS FOR MAP INTERACTION OF VIRTUAL SCENE, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Liang KANG, Shenzhen (CN); Wei QIN, Shenzhen (CN); Danxing XU, Shenzhen (CN); Tian ZHANG, Shenzhen (CN)

(21) Appl. No.: 18/630,924

(22) Filed: Apr. 9, 2024

Related U.S. Application Data
(63) Continuation of application No. PCT/CN2023/086974, filed on Apr. 7, 2023.

(30) Foreign Application Priority Data
May 13, 2022 (CN) 202210524965.5

(51) Int. Cl. G06T 15/20; G06T 3/40

(52) U.S. Cl. CPC G06T 15/205; G06T 3/40

(57) ABSTRACT

This application provides a method for adjusting a virtual scene performed by an electronic device. The method includes: receiving a scale operation on a virtual scene in a global state; in accordance with a determination that a scale ratio corresponding to the scale operation is in a scale ratio interval corresponding to an enlarged state: causing a first angle between the screen and a first plane on which an enlarged state canvas is located, the enlarged state canvas comprising a ground layer and a grid layer, wherein the grid layer including a plurality of grids is displayed grid layer based on first transparency and the ground layer including a ground material of the virtual scene is displayed grid layer based on second transparency; and displaying an attachment layer above the ground layer on a second plane based on third transparency, wherein the second plane is parallel to the screen.

### CROSS-REFERENCE TO RELATED APPLICATIONS

This application is a continuation application of PCT Patent Application No. PCT/CN2023/086974, entitled “METHOD AND APPARATUS FOR MAP INTERACTION OF VIRTUAL SCENE, ELECTRONIC DEVICE, COMPUTER-READABLE STORAGE MEDIUM, AND COMPUTER PROGRAM PRODUCT” filed on Apr. 7, 2023, which claims priority to Chinese Patent Application No. 202210524965.5, entitled “METHOD AND APPARATUS FOR MAP INTERACTION OF VIRTUAL SCENE, ELECTRONIC DEVICE, COMPUTER-READABLE STORAGE MEDIUM, AND COMPUTER PROGRAM PRODUCT” filed on May 13, 2022, all of which is incorporated herein by reference in its entirety.

### FIELD OF THE TECHNOLOGY

This application relates to computer technologies, and in particular, to a method and an apparatus for map interaction of a virtual scene, an electronic device, a computer-readable storage medium, and a computer program product.

### BACKGROUND OF THE DISCLOSURE

Display technologies based on graphics processing hardware expand channels of perceiving an environment and obtaining information. Particularly, the display technology of virtual scenes can implement diversified interactions between virtual objects controlled by a user or artificial intelligence according to actual application requirements, and has a variety of typical application scenes, for example, in virtual scenes such as games, a real battle process between virtual objects can be simulated.

In the related art, a map of a virtual scene may be displayed through a 2D grid map, a 3D grid map, or the like. However, a development cost of the 3D grid map is high, and there are high limitations on a type of game and hardware conditions of a game hosting platform. Therefore, a game in which a system is mainly a 2D interface cannot use the 3D grid map. However, the 2D map has a poor visual perception effect, does not have real perspective, and cannot show vastness of an exploration region. A better solution to contradiction between resource consumption and a perspective depth of a map of a virtual scene is not proposed in the related art.

### SUMMARY

The embodiments of this application provide a method and an apparatus for map interaction of a virtual scene, an electronic device, a computer-readable storage medium, and a computer program product, capable of implementing a three-dimensional perspective effect of a virtual scene with low resource consumption.

The technical solutions of the embodiments of this application are implemented as follows:

An embodiment of this application provides a method for adjusting a virtual scene on a screen, the method including:
receiving a scale operation on a virtual scene, wherein the virtual scene is in a global state;
in accordance with a determination that a scale ratio corresponding to the scale operation is in a scale ratio interval corresponding to an enlarged state:
causing a first angle between the screen and a first plane on which an enlarged state canvas is located, the enlarged state canvas comprising a ground layer and a grid layer, wherein the grid layer including a plurality of grids is displayed grid layer based on first transparency and the ground layer including a ground material of the virtual scene is displayed grid layer based on second transparency; and displaying an attachment layer above the ground layer on a second plane based on third transparency, wherein the second plane is parallel to the screen.

An embodiment of this application provides an electronic device, including:
a memory, configured to store executable instructions; and
a processor, configured to implement, when executing the executable instruction stored in the memory, the method for adjusting a virtual scene on a screen provided in the embodiments of this application.

An embodiment of this application provides a non-transitory computer-readable storage medium, storing executable instructions, the executable instructions, when executed by a processor of an electronic device, causing the electronic device to implement the method for adjusting a virtual scene on a screen provided in the embodiments of this application.

The embodiments of this application have the following beneficial effects:

The ground layer is displayed above the grid layer based on the second transparency, and the attachment layer is displayed above the ground layer based on the third transparency, forming a layered visual effect of a 2D grid map; and the plane on which the attachment layer is located is maintained to be parallel to the screen, and the angles between planes on which a map layer and the grid layer are located and the screen are controlled, so that a map of the virtual scene can be presented in the screen of the terminal device with a visual effect that a closer object looks larger, thereby presenting a three-dimensional perspective effect. A perspective depth effect can be implemented based on materials of the 2D grid map, without setting a 3D grid map. In this way, compared with implementing a perspective effect through the 3D grid map, resources required for implementing the perspective effect are reduced.

### BRIEF DESCRIPTION OF THE DRAWINGS

FIG. 1A is a schematic diagram of an application mode of a method for map interaction of a virtual scene according to an embodiment of this application.

FIG. 1B is a schematic diagram of an application mode of a method for map interaction of a virtual scene according to an embodiment of this application.

FIG. 2 is a schematic structural diagram of a terminal device 400 according to an embodiment of this application.

FIG. 3A is a schematic flowchart of a method for map interaction of a virtual scene according to an embodiment of this application.

FIG. 3B is a schematic flowchart of a method for map interaction of a virtual scene according to an embodiment of this application.

FIG. 4A is a first schematic diagram of a layer according to an embodiment of this application.

FIG. 4B is a second schematic diagram of a layer according to an embodiment of this application.

FIG. 4C is a third schematic diagram of a layer according to an embodiment of this application.

FIG. 4D is a fourth schematic diagram of a layer according to an embodiment of this application.

FIG. 5A is a first schematic diagram of a map according to an embodiment of this application.

FIG. 5B is a second schematic diagram of a map according to an embodiment of this application.

FIG. 5C is a third schematic diagram of a map according to an embodiment of this application.

FIG. 5D is a fourth schematic diagram of a map according to an embodiment of this application.

FIG. 5E is a first schematic diagram of a layer material according to an embodiment of this application.

FIG. 5F is a second schematic diagram of a layer material according to an embodiment of this application.

FIG. 6A is a first side view of planes on which layers are located according to an embodiment of this application.

FIG. 6B is a second side view of planes on which layers are located according to an embodiment of this application.

FIG. 6C is a schematic diagram of a linear relationship between an angle and a scale ratio according to an embodiment of this application.

FIG. 7A is a first schematic bar diagram of a relationship between layer transparency and a scale ratio according to an embodiment of this application.

FIG. 7B is a second schematic bar diagram of a relationship between layer transparency and a scale ratio according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, related “some embodiments” describe a subset of all possible embodiments. However, it may be understood that the “some embodiments” may be the same subset or different subsets of all the possible embodiments, and may be combined with each other without conflict.

In the following descriptions, the related term “first/second/third” is merely intended to distinguish similar objects but does not necessarily indicate a specific order of an object. It may be understood that the “first/second/third” is interchangeable in terms of a specific order or sequence if permitted, so that the embodiments of this application described herein can be implemented in a sequence in addition to the sequence shown or described herein.

In the embodiments of this application, user information, user feedback data, and other related data are involved, and when the embodiments of this application are applied to specific products or technologies, user authorization or consent is required, and the collection, use, and processing of the related data need to comply with the relevant laws, regulations, and standards of the relevant countries and regions.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are further described in detail, terms involved in the embodiments of this application are described. The terms provided in the embodiments of this application are applicable to the following explanations.
(1) Virtual scene: It is a scene that is distinguished from the real world and outputted by using a device, where visual perception of the virtual scene can be formed with aid of naked eyes or devices, for example, by using two-dimensional images outputted by using a display screen or three-dimensional images outputted by using a three-dimensional display technology such as a three-dimensional projection, virtual reality, or augmented reality technology. In addition, a variety of perception simulating the real world such as auditory perception, tactile perception, olfactory perception, and motion perception may further be formed by using a variety of possible hardware.
(2) In response to: It is used for representing a condition or a status on which an operation to be performed depends. When the condition or the status is satisfied, one or more operations may be performed in real time or may be performed after a set delay. Unless explicitly stated, there is no limitation on an order in which a plurality of operations are performed.
(3) Grid map: It is a common presentation form of a map in games. A grid with a regular geometric shape is used as a smallest unit of the map, exploration elements such as buildings, mountains, rivers, forests, and virtual monsters (an attachment layer of the embodiments of this application includes these exploration elements) are flexibly arranged on each smallest unit, and a map with hundreds to even thousands of grids is formed for exploration and challenge of a player.
(4) Two-level scalable map: It is a map that can be displayed in two modes: a global state (that is, a reduced state) and an enlarged state. For a map of an ultra-large region, the map needs to support scale switching between the “global state” and the “enlarged state”, so that a user can conveniently and quickly obtain a global overview of the map and a detailed view of local region information.
(5) Global state: It is a state of reducing display in a two-level scalable map, and reducing a virtual scene for viewing a global map. Content displayed in the global state map is briefer than that in an enlarged state, such as: a basic terrain, a regional weather, a field of view, and other overview information.
(6) Enlarged state: It is a state of enlarging display in a two-level scalable map, and enlarging a virtual scene for viewing detailed information of a local region. More dimensions of information are displayed in a map in an enlarged state than in a global state, such as: a specific terrain, a regional specific layout, a weather range, a field of view, position distribution of creatures in the map, and other detailed information.
(7) Field of view mist: It is a special effect material of a map in games, and is applied to a region that a player does not explore, causing a map region unexplored by the player to be shrouded by a mist material, and the player needs to control a virtual object to travel to the unexplored map region to unlock a field of view of the unexplored map region.
(8) Canvas angle: It is an angle between a virtual plane on which a canvas is located and a screen of a terminal device.
(9) Perspective effect: It is that when a same object is located at different positions, if the object is closer, the object is larger in the eyes of a viewer; and if the object is farther, the object looks smaller. Such change is explained by the rules of drawing and is referred to as the perspective effect.

The embodiments of this application provide a method for map interaction of a virtual scene, an apparatus for map interaction of a virtual scene, an electronic device, a computer-readable storage medium, and a computer program product, which can implement a three-dimensional perspective effect in a 2D grid map of a virtual scene, and reduce graphics computing resource consumption required for the map of the virtual scene.

The electronic device provided in the embodiments of this application may be implemented as a notebook computer, a tablet computer, a desktop computer, a set-top box, or a mobile device (for example, various types of user terminals such as a mobile phone, a portable music player, a personal digital assistant, a dedicated messaging device, a portable game device, an in-vehicle terminal, a virtual reality (VR) device, and an augmented reality (AR) device), or may be implemented as a server.

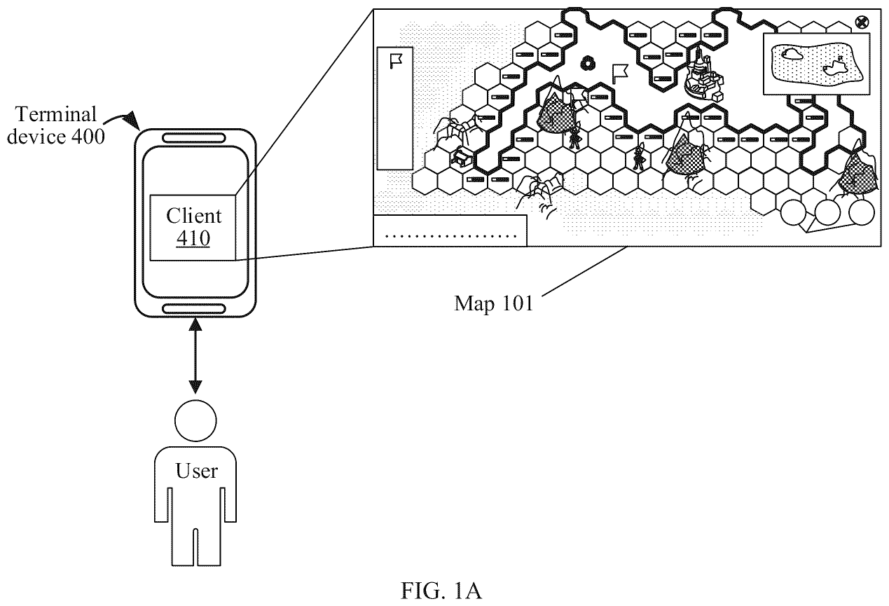

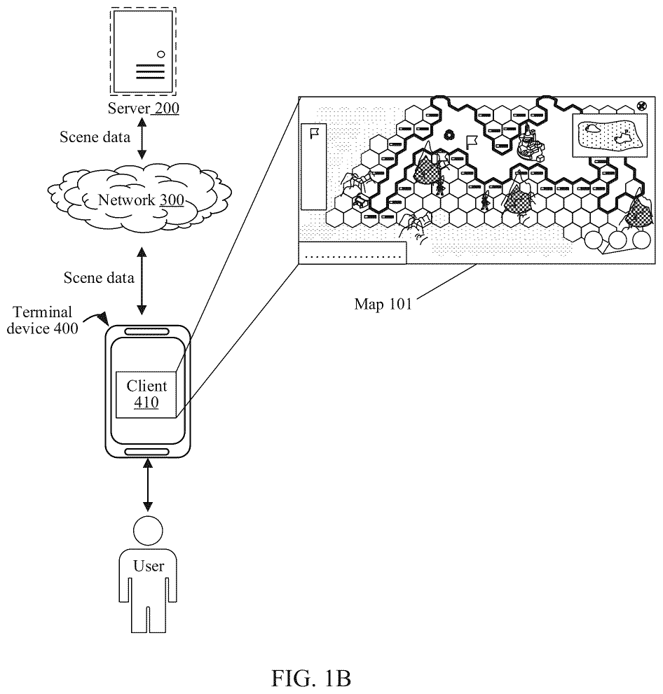

In an implementation scene, FIG. 1A is a schematic diagram of an application mode of a method for map interaction of a virtual scene according to an embodiment of this application, which is applied to some application modes in which related data computing of the virtual scene can be completed completely depending on a graphics processing hardware computing capability of a terminal device 400, for example, in a stand-alone/offline mode of a game, a virtual scene is outputted through different types of the terminal devices 400 such as a smartphone, a laptop computer, and a virtual reality/an augmented reality device.

For example, types of graphics processing hardware include a central processing unit (CPU) and a graphics processing unit (GPU).

When visual perception of the virtual scene is formed, the terminal device 400 computes data required for display by using the graphics processing hardware, loads, parses, and renders the data to be displayed, and outputs a video frame that can form the visual perception for the virtual scene in graphics output hardware, for example, presents a two-dimensional video frame on a display screen of a smartphone, or projects a video frame with a three-dimensional display effect on lenses of augmented reality/virtual reality glasses. In addition, to enrich the perception effect, the terminal device 400 may also form one or more of auditory perception, tactile perception, motion perception, and gustatory perception.

For example, a client 410 (for example, a stand-alone game application) runs in the terminal device 400. A map 101 of a virtual scene is displayed in the client 410, and the map may indicate a current state of a region in which a first virtual object controlled by a user is located. The first virtual object is controlled by a real user, and moves in the virtual scene in response to an operation of the user for a controller (such as a touch screen, a voice control switch, a keyboard, a mouse, and a joystick). For example, when the real user moves the joystick rightward, the first virtual object moves to the right in the virtual scene. The first virtual object may also maintain stationary and jump, and may be controlled to perform a shooting operation and the like.

For example, the terminal device 400 performs the following operations in response to a scale operation for the virtual scene when a scale ratio corresponding to the scale operation is in a scale ratio interval corresponding to an enlarged state: displaying a grid layer based on first transparency, the grid layer including a plurality of grids; displaying a ground layer above the grid layer based on second transparency, the ground layer including a ground material of the virtual scene; controlling a first plane on which an enlarged state canvas is located and a screen to form a first angle, the enlarged state canvas including the ground layer and the grid layer; displaying an attachment layer above the ground layer based on third transparency; and controlling a second plane on which the attachment layer is located to be parallel to the screen of the terminal device.

In another implementation scene, FIG. 1B a schematic diagram of an application mode of a method for map interaction of a virtual scene according to an embodiment of this application, which is applied to the terminal device 400 and a server 200, and is applicable to an application mode in which virtual scene computing is completed depending on a computing capability of the server 200 and the virtual scene is outputted in the terminal device 400.

By using the visual perception forming the virtual scene as an example, the server 200 computes display data (for example, scene data) related to the virtual scene, and sends the display data to the terminal device 400 through a network 300. The terminal device 400 loads, parses, and renders the computed display data depending on the graphics computing hardware, and forms the visual perception depending on the graphics output hardware outputting the virtual scene, for example, presents a two-dimensional video frame on a display screen of a smartphone, or projects a video frame with a three-dimensional display effect on lenses of augmented reality/virtual reality glasses. It may be understood that perception of a form of the virtual scene may be outputted by using corresponding hardware of the terminal device 400, for example, a microphone is used to form the auditory perception, and a vibrator is used to form the tactile perception.

For example, a client 410 (for example, an online game application) runs in the terminal device 400, which performs game interaction with other users by connecting the server 200 (for example, a game server). The terminal device 400 outputs a map 101 of a virtual scene of the client 410, and the map may indicate a current state of a region in which a first virtual object controlled by a user is located. The first virtual object is controlled by a real user, and moves in the virtual scene in response to an operation of the user for a controller (such as a touch screen, a voice control switch, a keyboard, a mouse, and a joystick). For example, when the real user moves the joystick rightward, the first virtual object moves to the right in the virtual scene. The first virtual object may also maintain stationary and jump, and may be controlled to perform a shooting operation and the like.

For example, the terminal device 400 performs the following operations in response to a scale operation for the virtual scene when a scale ratio corresponding to the scale operation is in a scale ratio interval corresponding to an enlarged state: displaying a grid layer based on first transparency, the grid layer including a plurality of grids; displaying a ground layer above the grid layer based on second transparency, the ground layer including a ground material of the virtual scene; controlling a first plane on which an enlarged state canvas is located and a screen to form a first angle, the enlarged state canvas including the ground layer and the grid layer; displaying an attachment layer above the ground layer based on third transparency; and controlling a second plane on which the attachment layer is located to be parallel to the screen of the terminal device.

In some embodiments, the terminal device 400 may implement the method for map interaction of a virtual scene provided in the embodiments of this application by executing a computer program. For example, the computer program may be a native program or a software module in an operating system; may be a native application (APP), that is, a program that needs to be installed in the operating system to run, for example, a shooting game APP (that is, the client 410); may be a mini program, that is, a program that only needs to be downloaded into a browser environment to run; or may be a game applet that can be embedded in any APP. In conclusion, the computer program may be an application, a module, or a plug-in in any form.

An example in which the computer program is an application is used. During practical implementation, an application supporting a virtual scene is installed and runs in the terminal device 400. The application may be any one of a first-person shooting game (FPS), a third-person shooting game, a virtual reality application, a three-dimensional map program, or a multiplayer survival game. The user uses the terminal device 400 to operate a map corresponding to the virtual scene for scaling. The user uses the terminal device 400 to operate a virtual object in the virtual scene to perform activities. The activities include, but are not limited to, at least one of adjusting body postures, crawling, walking, running, riding, jumping, driving, picking, shooting, attacking, throwing, and building a virtual building. For example, the virtual object may be a virtual character, such as a simulated character role or a cartoon character role.

In some other embodiments, the embodiments of this application may also be implemented by using a cloud technology. The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. A cloud computing technology becomes an important support. A background service of a technical network system requires a large amount of computing and storage resources. Cloud gaming may also be referred to as gaming on demand, which is an online game technology based on the cloud computing technology. The cloud gaming technology allows a thin client with relatively limited graphics processing and data computing capabilities to run a high-quality game. In a scene of the cloud gaming, a game is not in a game terminal of a player, but runs in a cloud server, and the cloud server renders a game scene into a video stream and an audio stream, and transmits the video stream and the audio stream to the game terminal of the player through the network. The game terminal of the player does not need to have powerful graphics computing and data processing capabilities, and only needs to have a basic streaming media playback capability and a capability of obtaining an input instruction of the player and sending the input instruction to the cloud server.

For example, the server 200 in FIG. 1A and FIG. 1B may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a CDN, big data, and an artificial intelligence platform. The terminal device 400 in FIG. 1A and FIG. 1B may be a smartphone, a tablet computer, a notebook computer, a desktop computer, a smart speaker, a smartwatch, or the like, but is not limited thereto. The terminal device 400 and the server 200 may be directly or indirectly connected in a wired or wireless communication manner. This is not limited in the embodiments of this application.

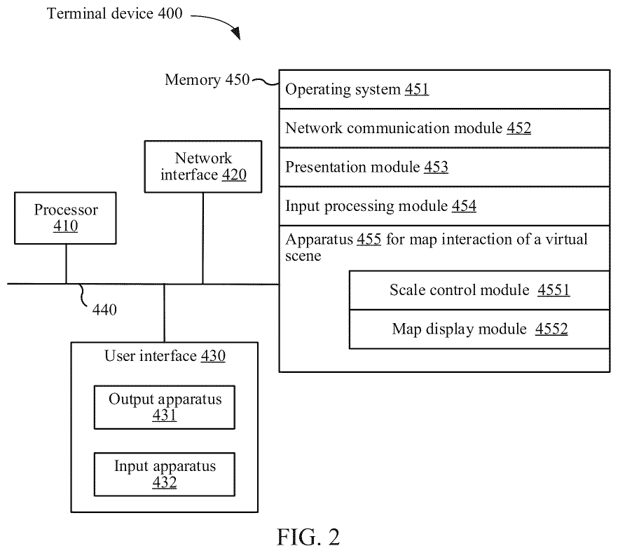

A structure of the terminal device 400 shown in FIG. 1A is described below. FIG. 2 is a schematic structural diagram of a terminal device 400 according to an embodiment of this application. The terminal device 400 shown in FIG. 2 includes: at least one processor 410, a memory 450, at least one network interface 420, and a user interface 430. All the components in the terminal device 400 are coupled together by using a bus system 440. It may be understood that, the bus system 440 is configured to implement connection and communication between the components. In addition to a data bus, the bus system 440 further includes a power bus, a control bus, and a state signal bus. However, for ease of clear description, all types of buses in FIG. 2 are marked as the bus system 440.

The processor 410 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The user interface 430 includes one or more output apparatuses 431 that can display media content, including one or more speakers and one or more visual display screens. The user interface 430 further includes one or more input apparatuses 432, including user interface components that facilitate inputting of a user, such as a keyboard, a mouse, a microphone, a touch display screen, a camera, and other input buttons and controls.

The memory 450 may be a removable memory, a non-removable memory, or a combination thereof. For example, hardware devices include a solid-state memory, a hard disk drive, an optical disc driver, or the like. The memory 450 includes one or more storage devices physically away from the processor 410.

The memory 450 includes a volatile memory or a non-volatile memory, or may include both a volatile memory and a non-volatile memory. The non-volatile memory may be a read-only memory (ROM). The volatile memory may be a random access memory (RAM). The memory 450 described in the embodiments of this application is to include any other suitable type of memories.

In some embodiments, the memory 450 can store data to support various operations. Examples of the data include a program, a module, and a data structure, or a subset or a superset thereof, which are described below by using examples.

An operating system 451 includes a system program configured to process various basic system services and perform a hardware-related task, for example, a framework layer, a core library layer, and a driver layer, and is configured to implement various basic services and process a hardware-related task.

A network communication module 452 is configured to reach another computing device through one or more (wired or wireless) network interfaces 420. Exemplary network interfaces 420 include: Bluetooth, wireless compatible authentication (Wi-Fi), a universal serial bus (USB), and the like.

A presentation module 453 is configured to present information by using one or more output apparatuses 431 (for example, a display screen and a speaker) associated with the user interface 430 (for example, a user interface configured to operate a peripheral device and display content and information).

An input processing module 454 is configured to detect one or more user inputs or interactions from one of the one or more input apparatuses 432 and translate the detected input or interaction.

In some embodiments, the apparatus for map interaction of a virtual scene provided in the embodiments of this application may be implemented in a form of software. FIG. 2 shows an apparatus 455 for map interaction of a virtual scene stored in the memory 450, which may be software in a form of a program and a plug-in, and includes the following software modules: a scale control module 4551 and a map display module 4552. In FIG. 2, for ease of description, the modules are shown at one time, but it is not considered that the apparatus 455 for map interaction of a virtual scene excludes an implementation in which only the scale control module 4551 and the map display module 4552 are included. These modules are logical, and therefore, can be combined or further divided according to functions implemented.

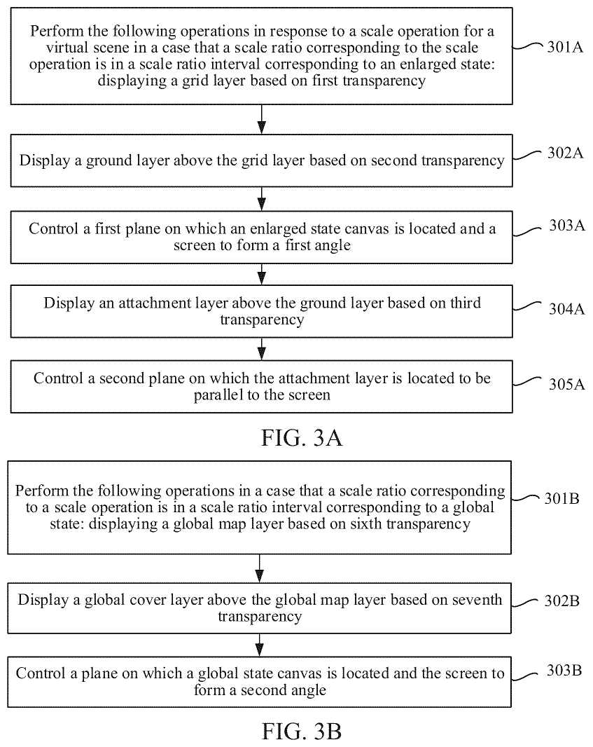

The method for map interaction of a virtual scene provided in the embodiments of this application is described in detail below with reference to the accompanying drawings. The method for map interaction of a virtual scene provided in the embodiments of this application may be performed by the terminal device 400 in FIG. 1A, or may be performed by the terminal device 400 and the server 200 in FIG. 1B in cooperation. FIG. 3A is a schematic flowchart of a method for map interaction of a virtual scene according to an embodiment of this application, and the method is described with reference to steps shown in FIG. 3A.

In step 301A, the following operation is performed in response to a scale operation for a virtual scene when a scale ratio corresponding to the scale operation is in a scale ratio interval corresponding to an enlarged state: displaying a grid layer based on first transparency.

For example, the virtual scene in this embodiment of this application is a 2D two-level scalable map. A scale ratio interval of the two-level scalable map includes: a scale ratio interval corresponding to an enlarged state (displaying the map in the enlarged state), a scale ratio interval corresponding to a global state (displaying the map in the global state), and a scale ratio interval corresponding to a transitional state (a process of switching between the two states).

For example, for a scale ratio S, the scale ratio interval corresponding to the enlarged state is 100%≥S>a %, the scale ratio interval corresponding to the transitional state is a %≥S≥b %, and the scale ratio interval corresponding to the global state is b %>S≥10%. a and b are values greater than 0 or less than 100, for example, a is 70, and b is 40.

For example, transparency is a parameter configured for indicating a degree of transparency, and a value range of the transparency is 0% to 100%. The transparency is negatively correlated to visibility, and higher transparency indicates lower visibility; otherwise, lower transparency indicates higher visibility. For example, higher transparency of an image material indicates lower visibility of the image material, and if the transparency of the image material reaches 100%, the visibility of the image material is 0.

For example, the transparency of the grid layer in the enlarged state is determined based on a preconfigured value range. For example, a preconfigured value range corresponding to first transparency T1 is 20%≥T1≥0%, so that the map in the enlarged state is clearer. The enlarged state is a state of presenting enlarged details of a local map. In the enlarged state, based on display of the local map, the map is enlarged or reduced in response to the scale operation for the map.

The grid layer includes a plurality of grids.

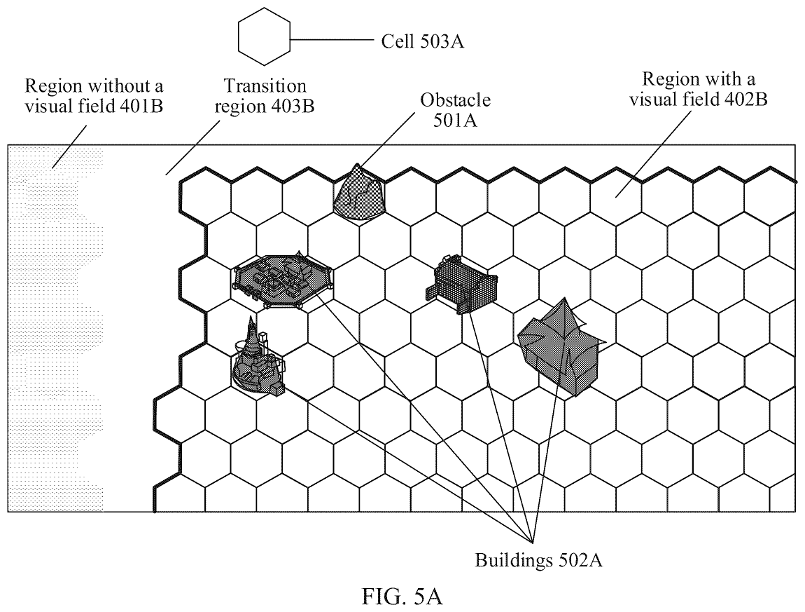

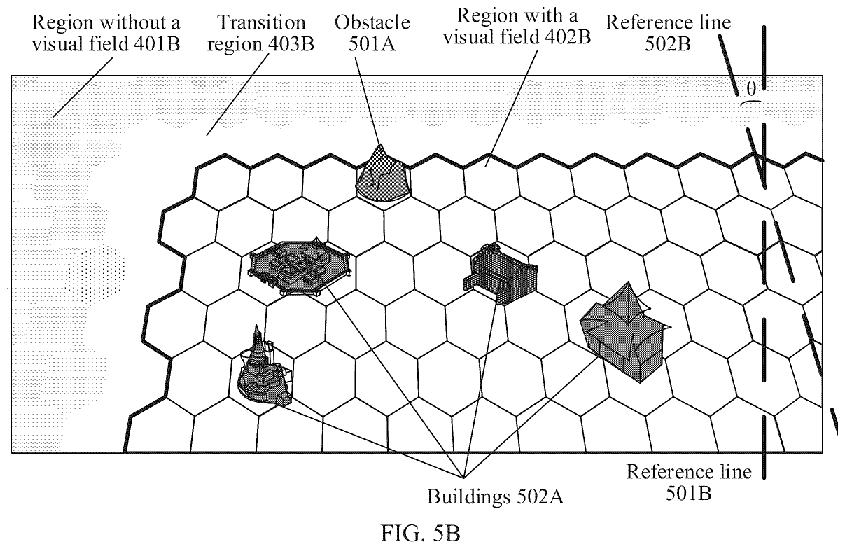

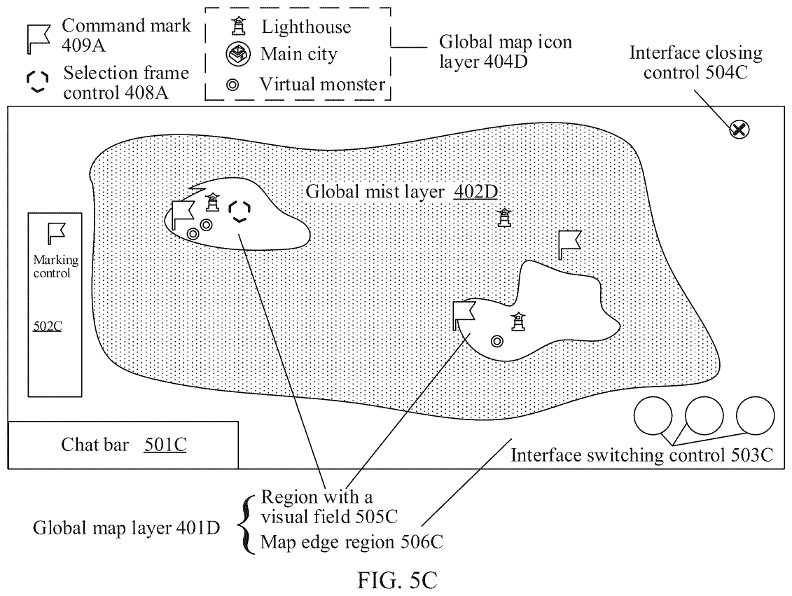

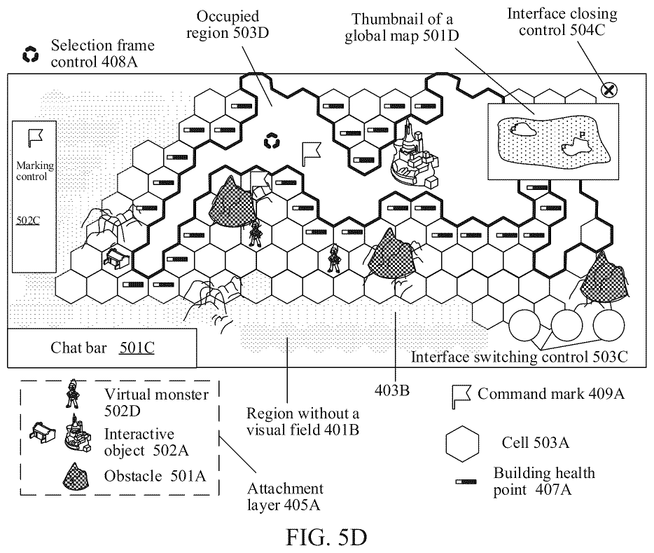

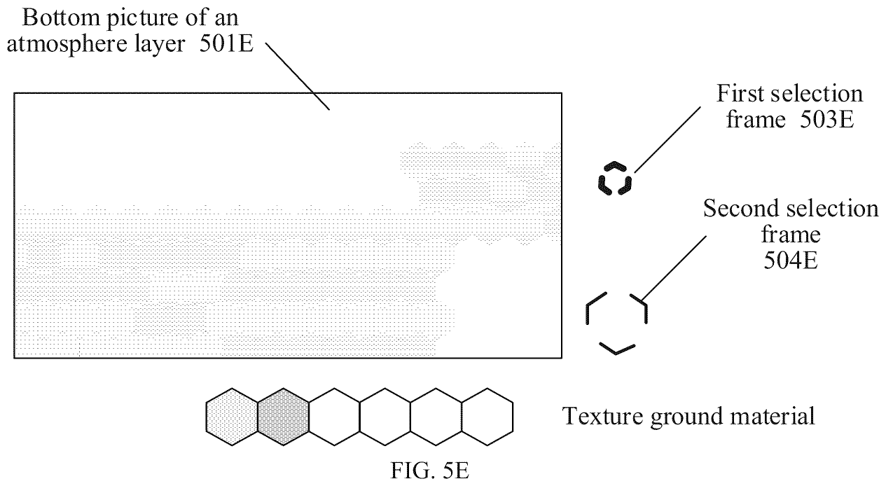

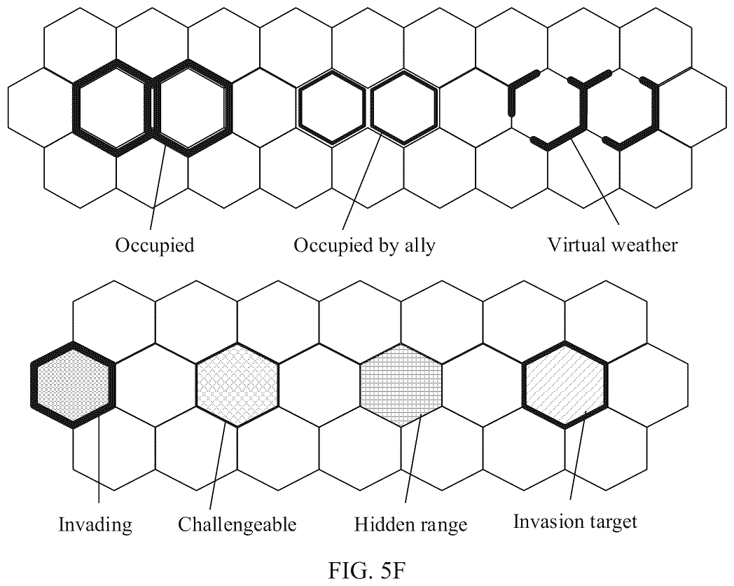

For example, each grid in the grid layer has the same shape and size. The shape of each grid is, for example, a square, a rectangle, a triangle, a pentagon, a hexagon, or the like. In this embodiment of this application, an example in which each grid (referred to as a cell below) in the grid layer is a hexagonal grid is used for description. FIG. 5A is a first schematic diagram of a map according to an embodiment of this application. A hexagonal cell 503A is a minimum geometric unit of the grid layer, and the grid layer includes a plurality of cells.

In step 302A, a ground layer is displayed above the grid layer based on second transparency.

For example, the ground layer includes at least one type of texture ground material of the virtual scene, and a material in the ground layer may be configured to indicate that a region in which a plot is located has a connected or an unconnected state.

For example, a state of the region in which each plot is located may be indicated by using a different texture ground material corresponding to the plot in the ground layer. For example, a light-colored texture ground material indicates that the region in which the plot is located is between an unexplored region and an explored region. FIG. 5E is a first schematic diagram of a layer material according to an embodiment of this application. In FIG. 5E, each hexagonal grid corresponds to a different texture ground material, and different texture ground materials may indicate different terrains and textures.

For example, the second transparency of the ground layer in the enlarged state may be the same as the first transparency of the grid layer, or the second transparency T2 of the ground layer is less than the first transparency T1 of the grid layer, where T1≥T2≥0%.

In step 303A, a first plane on which an enlarged state canvas is located and a screen are controlled to form a first angle.

The enlarged state canvas includes the ground layer and the grid layer whose angles relative to the screen synchronously change.

For example, an angle value of the first angle may be a preset value. For the scale ratio S, the scale ratio interval corresponding to the enlarged state is 100%≥S>a %, the angle value of the first angle formed between the first plane on which the enlarged state canvas is located and the screen is b, and it is assumed that a is 40, and b is 70. In this case, the scale ratio interval corresponding to the enlarged state is 100%≥S>70%, and in the scale ratio interval corresponding to the enlarged state, the first plane on which the enlarged state canvas is located and the screen form an angle of 40°.

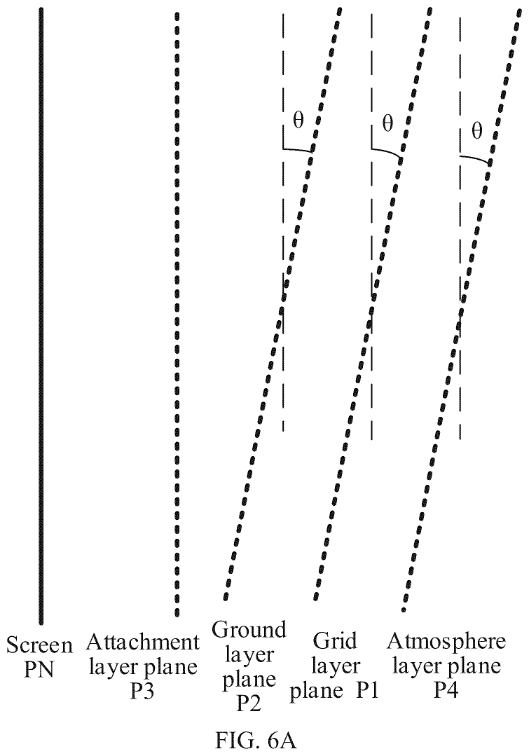

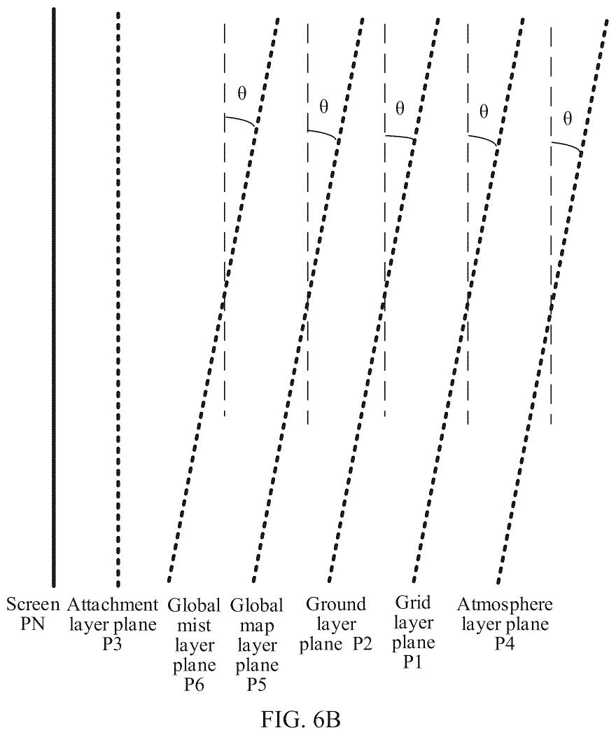

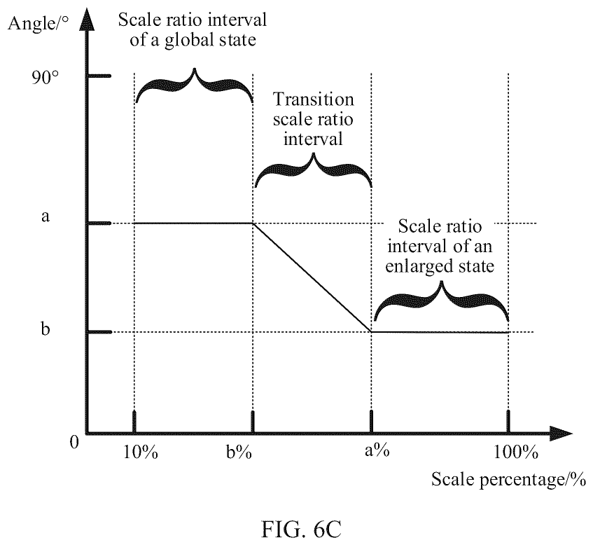

FIG. 6A is a first side view of planes on which layers are located according to an embodiment of this application. Each hierarchy of the two-level scalable map may be regarded as a layer, and it is assumed that each layer has a corresponding virtual plane. In this case, a ground layer plane P2 is parallel to a grid layer plane P1, an angle θ is respectively formed between the ground layer plane P2 and a screen PN and between the grid layer plane P1 and the screen PN, the ground layer plane P2 is superimposed on the grid layer plane P1, and the ground layer plane P2 and the grid layer plane P1 belong to the plane on which the enlarged state canvas is located.

In step 304A, an attachment layer is displayed above the ground layer based on third transparency.

For example, the attachment layer includes different types of attachments arranged on the ground layer. The types of the attachments include: interactive buildings, obstacles, and virtual invaders (for example, virtual monsters). The attachments are mutually exclusive, that is, only one attachment is displayed in the same grid. Still referring to FIG. 5A, an obstacle 501A is a mountain, and buildings 502A separately indicates different buildings. The third transparency of the attachment layer in the enlarged state may be the same as the first transparency of the grid layer and the second transparency of the ground layer, or the third transparency T3 of the attachment layer is less than the second transparency T2 of the ground layer, where T2≥T3≥0%.

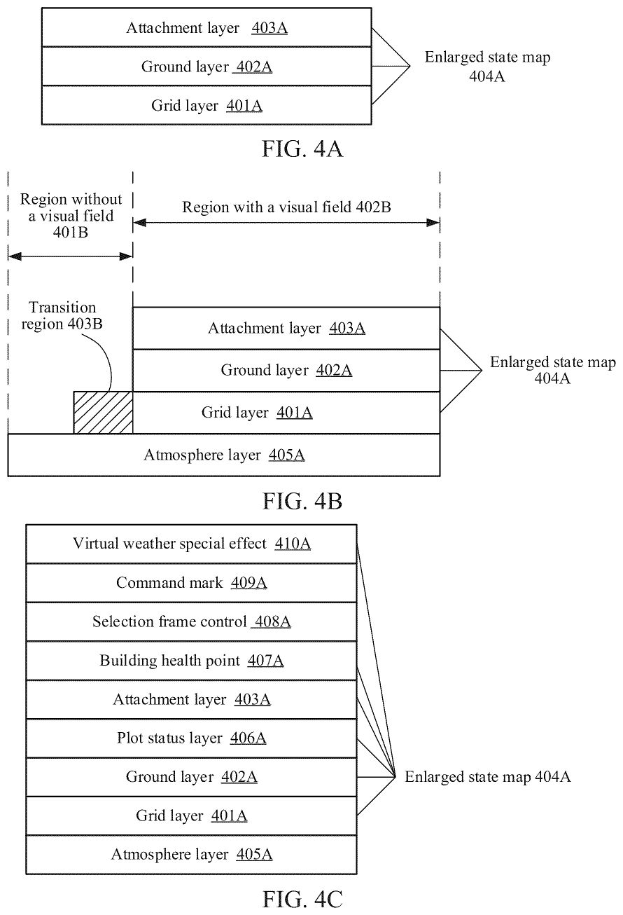

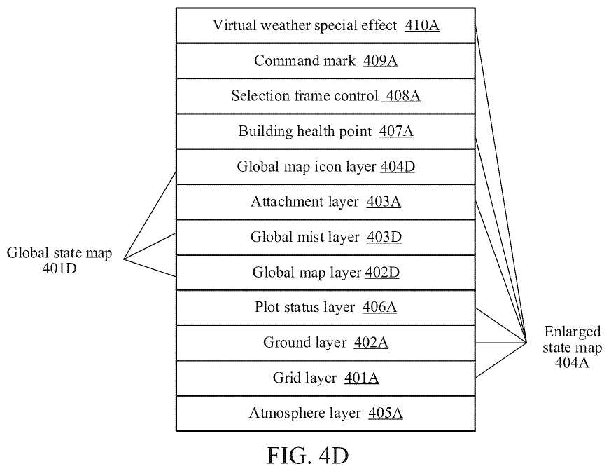

FIG. 4A is a first schematic diagram of a layer according to an embodiment of this application. An enlarged state map 404A includes: a grid layer 401A, a ground layer 402A above the grid layer 401A, and an attachment layer 403A above the ground layer 402A. The enlarged state canvas includes the ground layer 402A.

In this embodiment of this application, the grid layer is displayed in the first transparency, the ground layer is displayed in the second transparency, the attachment layer is displayed in the third transparency, and the layers are sequentially superimposed, so that the map of the virtual scene forms a visual effect with a layered sense. Compared with forming a layered sense of a map of the virtual scene by using a 3D grid map, implementing a layered sense of a map by using a 2D grid map reduces graphics computing resources consumed by the map of the virtual scene, and reduces internal memory required for the map of the virtual scene, so that application with other functions in the virtual scene can have more sufficient operating internal memory.

In step 305A, a second plane on which the attachment layer is located is controlled to be parallel to the screen.

For example, when the enlarged state map is viewed from the screen of the terminal device, there is an angle of a preset angle value between the plane on which the enlarged state canvas is located and the screen, and the grid layer and the ground layer in the map present an inclined visual effect. The plane on which the attachment layer is located always maintains parallel to the screen. An image material corresponding to the attachment layer presents a vertical visual effect relative to the grid layer and the ground layer, presenting a three-dimensional perspective effect that the image material corresponding to the attachment layer is vertical on the grid layer and the ground layer on the enlarged state canvas. That is, the image material of the plane corresponding to the attachment layer presents a three-dimensional effect relative to image materials of the grid layer and the ground layer.

FIG. 5B is a second schematic diagram of a map according to an embodiment of this application. A reference line 501B is parallel to a perpendicular line of an edge of the screen displaying the enlarged state map, a reference line 502B is parallel to planes on which the ground layer and the grid layer are respectively located, and an angle θ is formed between the reference line 502B and the reference line 501B. The angle θ is angles between the screen and the planes on which the ground layer and the grid layer are located. There are angles between the screen and the planes on which the ground layer and the grid layer are located, so that a distance between a grid on an upper portion of the map and a plane on which the screen is located is farther than a grid on a lower portion of the map and the plane on which the screen is located. Based on a principle of the perspective effect that a closer object looks larger, in the visual effect, the following picture is presented: a grid size on the upper portion of the map is less than a grid size on the lower portion of the map, that is, the three-dimensional perspective effect.

In this embodiment of this application, by reusing a 2D material of the 2D grid map, the three-dimensional perspective effect is implemented in the 2D grid map. The 2D grid map consumes less resources, when the terminal device runs a client corresponding to the virtual scene, using the 2D grid map in this embodiment of this application can implement the three-dimensional perspective effect and reduce operating internal memory of the client.

In some embodiments, adjustment of the scale ratio may be implemented in any following manner:
1. Scaling is performed based on shaking of a joystick in different directions, and the different directions of the joystick are, for example, up and down, and left and right. An example in which the different directions are up and down is used for description, the joystick is shaken upward to control the map to be enlarged, and the joystick is shaken downward to control the map to be reduced.
2. The scaling is performed based on different directions of a touch pad, for example, the map is scaled based on a sliding distance of an opposite sliding operation of two fingers. The sliding distance of the sliding operation is positively correlated to an adjusted scale ratio of the map. The opposite sliding operation of pinching two fingers together is configured to control the map to be reduced; otherwise, the opposite sliding operation of spreading two fingers is configured to control the map to be enlarged.
3. The scaling is performed based on an angle of scrolling a wheel of a mouse forward or backward. For example, the wheel of the mouse is scrolled forward to control the map to be enlarged; otherwise, the wheel of the mouse is scrolled backward to control the map to be reduced. The angle of scrolling the wheel of the mouse is positively correlated to the adjusted scale ratio of the map.

In some embodiments, the enlarged state canvas also includes an atmosphere layer. The atmosphere layer is displayed below the grid layer based on fourth transparency, the atmosphere layer, the ground layer, and the grid layer together forming the enlarged state canvas in a synchronously changing manner. The atmosphere layer includes at least one of the following materials: a dynamical special effect (for example, an animation of a fish swimming and an animation of clouds moving slowly), a background image including at least one color, and shading formed based on text tiling.

For example, a value range of the fourth transparency T4 may be 100%≥T4≥0%. The atmosphere layer may be displayed in all regions of the virtual scene by hiding each layer above the atmosphere layer. The atmosphere layer may indicate a transition animation of switching between game interfaces, or the atmosphere layer of all the regions may indicate that none of the regions is explored by the virtual object. Planes on which the atmosphere layer, the ground layer, and the grid layer are located are parallel to each other. Referring to FIG. 6A, an atmosphere layer plane P4 on which the atmosphere layer is located is parallel to the grid layer plane P1 and the ground layer plane P2, and the atmosphere layer may also enhance the three-dimensional perspective effect of the map.

In this embodiment of this application, the atmosphere layer with the fourth transparency is set, improving the layered sense of the map of the virtual scene, and the plane on which the atmosphere layer is located is controlled to be parallel to the planes on which the ground layer and the grid layer are located, so that the atmosphere layer can be configured for presenting the three-dimensional perspective effect of the map, enhancing the three-dimensional perspective effect of the map of the virtual scene.

In some embodiments, the first transparency to the fourth transparency may be the same, or according to the hierarchy of the layer corresponding to each transparency, the transparency is sequentially smaller in an order from the bottom up.

In some embodiments, the atmosphere layer may be used to implement a field of view mist effect. The grid layer, the ground layer, and the attachment layer are displayed in a region with a visual field of the virtual scene, the region with a visual field being a region that the virtual object controlled by a player once reached and explored in the virtual scene. That the atmosphere layer is displayed based on the fourth transparency may be implemented in the following manner: The atmosphere layer is displayed below the grid layer in the region with a visual field and a region without a visual field based on the fourth transparency, the region without a visual field being a region that the virtual object controlled by the player does not reach and explore in the virtual scene.

In this embodiment of this application, instead of covering the enlarged map by using an image material of sheet tiling mist, the grid layer, the ground layer, and the attachment layer in the region without a visual field are not displayed, and the atmosphere layer at the bottom is exposed. The atmosphere layer is displayed in the region without a visual field, and the grid layer, the ground layer, and the attachment layer are displayed in the region with a visual field, forming the field of view mist effect. Compared with the related art in which a mist material is added to implement a mist effect, this application reuses an original atmosphere layer, reducing resource consumption required for implementing the mist effect.

In some embodiments, a transition region may also be arranged on an outer edge at a joint between the region with a visual field and the region without a visual field, to implement seamless transition between different regions.

For example, the atmosphere layer is displayed below the grid layer in the transition region in a fading-in manner, and the attachment layer is displayed in a fading-out manner, the transition region being a region for transition from the region with a visual field to the region without a visual field in the virtual scene.

FIG. 4B is a second schematic diagram of a layer according to an embodiment of this application. The attachment layer 403A, the ground layer 402A, and the grid layer 401A are displayed in a region with a visual field 402B, and the three layers covers the atmosphere layer 405A, so that the atmosphere layer 405A is not displayed in the region with a visual field 402B. A grid layer 401B includes a transition region 403B, the transition region 403B is located between the region with a visual field and the region without a visual field, and the grid layer is displayed in the transition region 403B in the fading-out manner. The atmosphere layer 405A is displayed in the region without a visual field 401B, and the grid layer is displayed in the fading-out manner. Referring to FIG. 5B, an image material corresponding to the atmosphere layer is displayed in the region without a visual field 401B, and an image material of the transition region 403B of the grid layer is displayed in a fading-out manner, and the grid layer and the attachment layer (the obstacle 501A and the buildings 502A) are displayed in the region with a visual field 402B. Referring to FIG. 5E, a bottom picture 501E of the atmosphere layer is a preset shadow picture, and the bottom picture 501E of the atmosphere layer is the image material of the atmosphere layer displayed in the region without a visual field 401B in FIG. 5B.

In this embodiment of this application, the seamless transition between the region without a visual field and the region with a visual field is implemented through a gradient fading-out effect of the grid layer, an original image material of the two-level scalable map is reused, and the computing resources and the operating internal memory required for forming the field of view mist effect in the two-level scalable map are reduced.

In some embodiments, a plot status layer is displayed between the ground layer and the attachment layer based on fifth transparency, the plot status layer including at least one material, each material being attached to one grid, a material on each grid being configured for indicating a status of a region corresponding to the grid, types of the status including:

Type 1. Occupied, indicating that the region corresponding to the grid is occupied by a home camp.

Type 2. Occupied by ally, indicating that the region corresponding to the grid is occupied by an allied camp of the home camp. For example, states with opposite attributes are mutually exclusive, and different states with attributes that are not opposite may be superimposed in the same region. For example, the same grid can only be occupied or be occupied by ally, which are mutually exclusive, and do not coexist in one grid. For another example, the virtual weather and the occupied are not mutually exclusive, and the virtual weather and the occupied may be superimposed in one grid.

Type 3. A virtual weather, indicating that the region corresponding to the grid is in the virtual weather. For example, when the region corresponding to the grid is in a virtual weather state, in response to a selection operation for the grid, a virtual weather graphical material corresponding to the grid is displayed. The virtual weather may be superimposed on any state.

Type 4. Challengeable, indicating that the region corresponding to the grid is invaded by an enemy camp, and is capable of being seized by the home camp. For example, a challengeable state, the occupied, the occupied by ally are mutually exclusive, and a priority corresponding to the challengeable state is higher than a priority of other states, and an image material corresponding to the challengeable state is displayed superimposed on an image material of other states. For example, the virtual weather state and the challengeable state are displayed in the same grid, and the image material of the challengeable state is displayed superimposed on an image material of the virtual weather state.

Type 5. Invading, indicating that the region corresponding to the grid is invaded by the enemy camp.

Type 6. An invasion target, indicating that the region corresponding to the grid is the invasion target of the home camp.

Type 7. A hidden range, indicating that the region corresponding to the grid is the hidden region. For example, the hidden region is a region with which the virtual object cannot interact in the region with a visual field. For example, a region that prohibit a virtual object of a home camp from interacting.

In this embodiment of this application, according to different display priorities of different types of states, and mutually exclusive attributes and non-mutually exclusive attributes between the different types of states and other states, when information of each grid in the map is clear, a plurality of states in the same grid are prevented from being confused, improving the visual effect of the map of the virtual scene, and facilitating the user locating and searching for information in the map of the virtual scene.

FIG. 5F is a second schematic diagram of a layer material according to an embodiment of this application. FIG. 5F lists patterns of image materials respectively corresponding to the occupied, the occupied by ally, the challengeable, disabled, the invading, the invasion target, and the hidden range.

In some embodiments, a human-machine interaction layer is displayed above the attachment layer.

The human-machine interaction layer includes at least one material. A region other than the material in the human-machine interaction layer is transparent, so that a material of a lower layer of the material can be displayed, and each material is attached to one grid, configured for human-machine interaction based on the grid.

For example, types of the human-machine interaction include the following types:

Type 1. A virtual weather special effect, configured for presenting a virtual weather of a region corresponding to the grid in which the virtual weather special effect is located.

Type 2. A command mark, configured for presenting a task related to the region corresponding to the grid, the task being published by a virtual object having a command authority, and the task being performed by a virtual object of the same camp of the virtual object having the command authority reaching the region. For example, in response to a marking operation for any grid in the region with a visual field in the map, the command mark is displayed in the grid, and the task corresponding to the command mark and position information of the grid in which the command mark is located are sent to the virtual object of the same camp.

Type 3. A building health point, configured for presenting a health point or durability of a building on the grid.

Type 4. A selection frame control, configured to indicate that the grid is in a selected state.

For example, FIG. 4C is a third schematic diagram of a layer according to an embodiment of this application. The 2D grid map includes, from the bottom layer to the top layer: the atmosphere layer 405A, the grid layer 401A, the ground layer 402A, a plot status layer 406A, the attachment layer 403A, a building health point 407A, a selection frame control 408A, a command mark 409A, and a virtual weather special effect 410A. The virtual weather special effect 410A, the building health point 407A, the attachment layer 403A, the ground layer 402A, and the grid layer 401A belong to the enlarged state map 404A. The command mark 409A and the selection frame control 408A belong to the human-machine interaction layer corresponding to the map of the virtual scene.

FIG. 5D is a fourth schematic diagram of a map according to an embodiment of this application. FIG. 5D is a schematic diagram of the enlarged state map. The enlarged state map includes the region without a visual field 401B (including the grid layer 403 displayed in a fading-out state), the attachment layer 405A (including an enemy virtual monster 502D, the buildings 502A, and the obstacle 501A), an occupied region 503D (marked by using a marking frame corresponding to the “occupied” plot state), a marking control 502C, a chat bar 501C, an interface switching control 503C, an interface closing control 504C, and the selection frame control 408A.

For example, in response to a triggering operation for the marking control 502C, a map marking mode is entered. In response to a marking operation for any grid in the region with a visual field 402B in the map, the command mark 409A is displayed in the grid, and the task corresponding to the command mark and position information of the grid in which the command mark is located are sent to the virtual object of the same camp. The chat bar 501C is configured for presenting chat messages between users. The interface switching control 503C is configured to switch to another virtual scene interface related to a battle corresponding to the map; and hide the 2D grid map in response to a triggering operation for the interface closing control 504. The selection frame control 408A is configured to indicate that the grid in which a selection frame is located is in a selected state.

In some embodiments, display life cycles of materials are uniformly set, and all the display life cycles are the scale ratio interval corresponding to the enlarged state. That is, all elements on each layer corresponding to FIG. 4C can be displayed in the enlarged state.

In some embodiments, the display life cycles of a first part of materials (including the command mark and the selection frame control) are uniformly set, and the display life cycles are set to the scale ratio interval corresponding to the enlarged state; and the display life cycles of a second part of materials (including the building health point and the weather special effect) are set to a head sub-interval. The head sub-interval is a sub-interval cut from a head of the scale ratio interval, that is, a maximum endpoint value of the sub-interval is the same as a maximum endpoint value of the scale ratio interval, and a minimum endpoint value of the sub-interval is a non-endpoint value in the scale ratio interval.

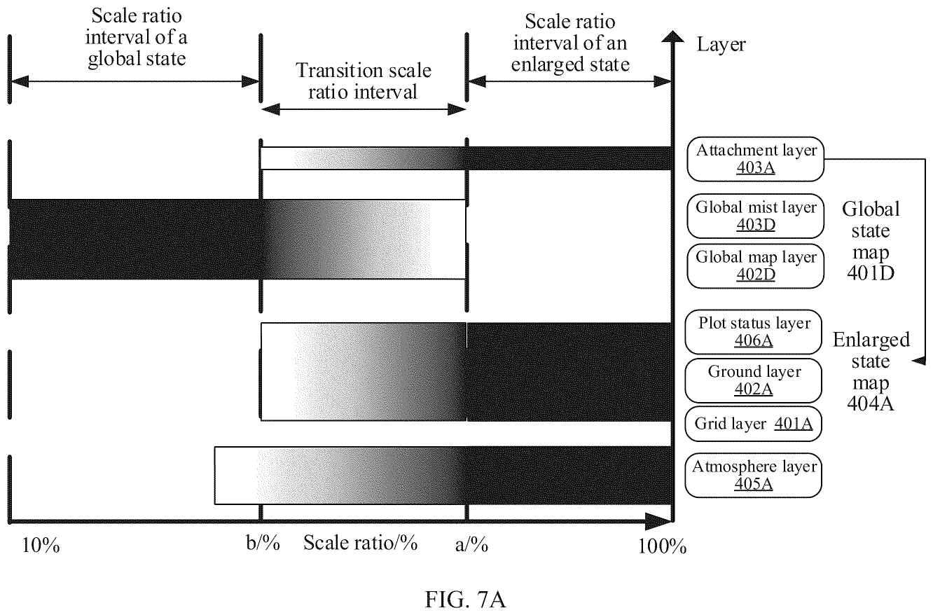

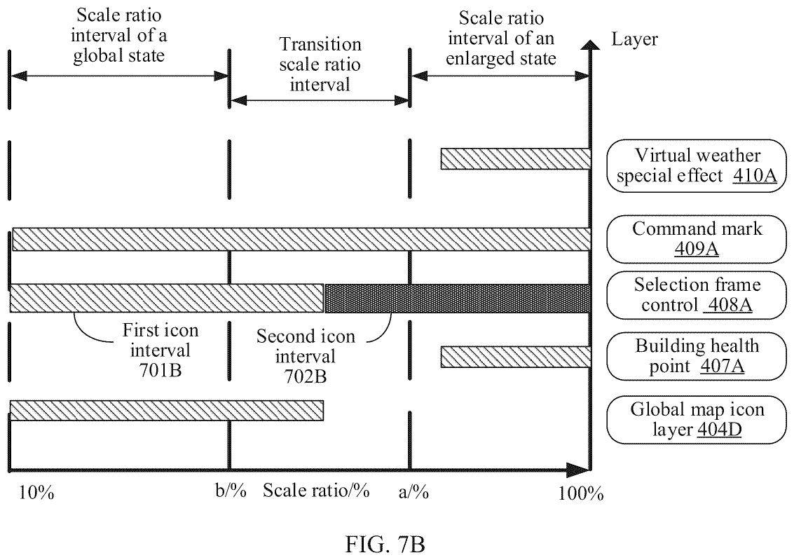

For example, FIG. 7B is a second schematic bar diagram of a relationship between layer transparency and a scale ratio according to an embodiment of this application. The command mark 409A and the selection frame control 408A are displayed in the same preset transparency at any scale ratio, for example, the transparency is 0%. The building health point 407A and the virtual weather special effect 410A are displayed at a scale ratio ranging from d % to 100 (50+a/2>d>a, and it is assumed that a is 70, in this case, d meets 85>d>70).

In some embodiments, the two-level scalable map includes a global map. FIG. 3B is a schematic flowchart of a method for map interaction of a virtual scene according to an embodiment of this application, and the method is described with reference to steps shown in FIG. 3B.

In step 301B, the following operations are performed when the scale ratio corresponding to the scale operation is in a scale ratio interval corresponding to a global state: displaying a global map layer based on sixth transparency.

The global map layer includes the global map of the virtual scene.

In step 302B, a global cover layer is displayed above the global map layer based on seventh transparency.

In an example, the global cover layer includes materials having a covering function such as mist and cloud. The global cover layer includes the material having the covering function to cover a region without a visual field in the global map, the region without a visual field being a region that the virtual object does not reach and explore in the virtual scene. The global cover layer may be used to implement a field of view mist effect in the global map, and the global cover layer may also be referred to as a global mist layer.

In some embodiments, the first transparency to the seventh transparency may be the same, or according to the hierarchy of the layer corresponding to each transparency, the transparency is sequentially smaller in an order from the bottom up.

In step 303B, a plane on which a global state canvas is located and the screen are controlled to form a second angle.

In an example, the plane on which the global state canvas is located and the screen are controlled to form the second angle, for example, an angle a, the global state canvas including the global map layer and the global cover layer, and the second angle being greater than the first angle.

For example, the angle value of the second angle may be a preset value. For the scale ratio S, the scale ratio interval corresponding to the global state is b %≥S>10%, and the angle value of the second angle formed between the second plane on which the global state canvas is located and the screen is a and it is assumed that b is 40, and a is 70. In this case, the scale ratio interval corresponding to the global state is 40%≥S>10%, and in the scale ratio interval corresponding to the global state, the second plane on which the global state canvas is located and the screen form an angle of 70°. FIG. 6B is a second side view of planes on which layers are located according to an embodiment of this application. A global mist layer plane P6 is parallel to a global map layer plane P5, and an angle θ is formed between the global mist layer plane P6 and the screen PN.

For example, the mist effect in the global state map may be implemented in the following manners: The global map layer is displayed in the region with a visual field. A mist image material of the global cover layer is displayed to cover the global map in the region without a visual field, forming the mist effect.

In this embodiment of this application, the mist image material is displayed in the map of the virtual scene, implementing an effect of distinguishing the unexplored region from the explored region in the map of the virtual scene, facilitating the user performing information location according to the map of the virtual scene. A manner of reusing the mist image material for distinguishing regions is used, reducing the graphics computing resources of the map of the virtual scene.

In some embodiments, a global map icon layer is displayed above the global cover layer, the global map icon layer being configured to replace the attachment layer displayed in the enlarged state, and including an icon corresponding to a material in the attachment layer, and a region other than the icon in the global map icon layer being transparent. According to this embodiment of this application, the global map icon layer can be displayed, and resource consumption required for the mist effect is reduced.

In an example, an icon corresponding to the material in the attachment layer includes at least one of the following: icons respectively corresponding to a building, an obstacle, an invader (for example, an invading virtual monster), and the region other than the icon in the global map icon layer is transparent, so that a lower layer can be presented.

FIG. 5C is a third schematic diagram of a map according to an embodiment of this application. FIG. 5C is a schematic diagram of the global state map displayed in the screen. A global map layer 401D is located below a global mist layer 402D (which is the global cover layer in the above). A part of regions of the global map layer 401D are blocked by the global mist layer 402D. The blocked region is an unexplored region, that is, a region without a visual field. An intermediate region that is of the global map layer 401D and that is not blocked by the global mist layer 402D is a region with a visual field 505C. An outer edge of an image material of the global mist layer 402D may be located in a map material of the global map layer 401D. Therefore, there is a map edge region 506C between an outer edge of the global mist layer 402D and the map material of the global map layer 401D. The global map icon layer 404D includes different types of global map icons, for example, a building icon (corresponding to the building indicated by a physical image in the attachment layer, such as a lighthouse and a main city) and a virtual monster icon (corresponding to the virtual monster indicated by a physical image in the attachment layer).

Functions of the marking control 502C, the interface switching control 503C, the interface closing control 504C, the chat bar 501C, and the selection frame control 408A in the global state map may refer to the foregoing enlarged state map, and are not repeated in detail herein. For example, referring to FIG. 5E, the selection frame control 408A is displayed as an icon corresponding to a first selection frame 503E in the enlarged state map, and is displayed as an icon corresponding to a second selection frame 504E in the global state map.

In this embodiment of this application, the global map icon layer is displayed above the global cover layer, implementing an effect of marking elements in regions of unexplored regions and explored regions in the map of the virtual scene, and enriching information content in the map of the virtual scene, thereby facilitating the user performing information location according to the map of the virtual scene.

In some embodiments, a transition scale ratio interval is set between the following two intervals: the scale ratio interval corresponding to the enlarged state and a scale ratio interval corresponding to a global state; and the following operations are performed when the scale ratio corresponding to the scale operation is in the transition scale ratio interval and gradually reduces: controlling the enlarged state canvas and the screen to form the first angle that gradually increases linearly, and forming a second angle between the enlarged state canvas and the screen when the scale ratio reduces to a minimum endpoint value of the transition scale ratio interval; and controlling a global state canvas and the screen to form the first angle that gradually increases, and forming the second angle between the global state canvas and the screen when the scale ratio reduces to the minimum endpoint value of the transition scale ratio interval.

The global state canvas including a global map layer and a global cover layer displayed in the global state.

For example, for ease of description, FIG. 6C is a schematic diagram of a linear relationship between an angle and a scale ratio according to an embodiment of this application. A horizontal axis of a coordinate axis is the scale ratio, and a vertical axis is angles between the planes on which the enlarged state canvas and the global state canvas are located and the screen. It is assumed that the scale ratio corresponding to the scale operation is in the transition scale ratio interval and gradually reduces, for example, the scale ratio S gradually changes from a % to b %, the minimum endpoint value is b %, and when coordinates (b %, a) are reached, the second angle is formed between the enlarged state canvas and the screen and between the global state canvas and the screen, where the angle value of the second angle is a.

In this embodiment of this application, the angle value of the first angle between the enlarged state canvas and the screen is adjusted along with the scale ratio, and the angle value of the first angle between the global state canvas and the screen is adjusted along with the scale ratio, so that the angle between the canvas and the screen is dynamically changed along with the scale ratio, implementing seamless switching between the enlarged map and the global map, and enhancing the three-dimensional perspective effect of the two-level scalable map.

In some embodiments, a transition scale ratio interval is set between the following two intervals: the scale ratio interval corresponding to the enlarged state and a scale ratio interval corresponding to a global state; and the following operations are performed when the scale ratio corresponding to the scale operation is in the transition scale ratio interval and gradually increases: controlling the enlarged state canvas and the screen to form the second angle that gradually increases linearly, and forming a first angle between the enlarged state canvas and the screen when the scale ratio increases to a maximum endpoint value of the transition scale ratio interval; and controlling a global state canvas and the screen to form the second angle that gradually reduces, and forming the first angle between the global state canvas and the screen when the scale ratio increases to the maximum endpoint value of the transition scale ratio interval.

For example, referring to FIG. 6C, it is assumed that the scale ratio corresponding to the scale operation is in the transition scale ratio interval and gradually increases, for example, the scale ratio S gradually changes from a % to b %, the maximum endpoint value is a %, and when coordinates (a %, b) are reached, the first angle is formed between the enlarged state canvas and the screen and between the global state canvas and the screen, where the angle value of the first angle is b.

In this embodiment of this application, the angle value of the first angle between the enlarged state canvas and the screen is adjusted along with the scale ratio, and the angle value of the first angle between the global state canvas and the screen is adjusted along with the scale ratio, so that the angle between the canvas and the screen is dynamically changed along with the scale ratio, implementing seamless switching between the enlarged map and the global map, and enhancing the three-dimensional perspective effect of the two-level scalable map.

In some embodiments, a manner of the angle value of the first angle being negatively correlated to the scale ratio includes: when a change value of the angle value of the first angle changes, a change value of the scale ratio linearly or non-linearly changes according to an opposite change trend. As the scale ratio reduces, and transitions from the enlarged state to the global state, the angles between the global state canvas and the screen, and between the enlarged state canvas and the screen change. A smaller scale ratio indicates a larger angle, simulating a 3D effect.

For example, referring to FIG. 6C, when the change value of the angle value of the first angle in FIG. 6C changes, the change value of the scale ratio linearly (in a straight line) changes according to the opposite change trend. In some embodiments, the change value of the scale ratio may alternatively linearly change in another form, for example, a curve, or may change in a non-linear form of discrete points.

In some embodiments, the transition scale ratio interval is set between the following two intervals: the scale ratio interval corresponding to the enlarged state and a scale ratio interval corresponding to a global state; and the following operations are performed when the scale ratio corresponding to the scale operation is in the transition scale ratio interval and gradually reduces: controlling at least a part of layers corresponding to the enlarged state to be reduced for display from a completely opaque state in a fading-out manner according to the scale ratio, the at least a part of layers corresponding to the enlarged state being completely transparent when the scale ratio reduces to the minimum endpoint value of the transition scale ratio interval; and controlling at least a part of layers corresponding to the global state to be reduced for display from a completely transparent state in a fading-in manner according to the scale ratio, the at least a part of layers corresponding to the enlarged state being completely opaque when the scale ratio reduces to the minimum endpoint value of the transition scale ratio interval.

All layers corresponding to the enlarged state and all layers corresponding to the global state have a same initial size.

For example, the at least a part of layers corresponding to the enlarged state may be at least one layer of the grid layer, the ground layer, the buildings in the attachment layer, the atmosphere layer, the building health point, the weather special effect, the command mark, and the selection frame control corresponding to the enlarged state. The at least a part of layers corresponding to the global state may be at least one layer of the global mist layer, the global map layer, and the global map icon layer according to the global state.

For example, it is assumed that the transition scale ratio interval of the scale ratio S is a %≥S≥b %. For example, a is 70, b is 40, and the minimum endpoint value is 40%. When the scale ratio is 70%, the at least a part of layers corresponding to the enlarged state is completely opaque (transparency being 0%), and the at least a part of layers corresponding to the global state is completely transparent (transparency being 100%). When S meets a %≥S≥b %, and the scale ratio gradually reduces, the transparency of the at least a part of layers corresponding to the enlarged state increases, and the transparency of the at least a part of layers corresponding to the global state reduces. When the scale ratio is the minimum endpoint value, which is 40%, the at least a part of layers corresponding to the enlarged state is completely transparent (the transparency being 100%), and the at least a part of layers corresponding to the global state is completely opaque (the transparency being 0%).

In this embodiment of this application, the transparency of the at least a part of layers corresponding to the enlarged state and the transparency of the at least a part of layers corresponding to the global state are adjusted along with the scale ratio, implementing seamless switching between the enlarged map and the global map, and enhancing the three-dimensional perspective effect of the two-level scalable map.

In some embodiments, the controlling at least a part of layers corresponding to the enlarged state to be reduced for display in a fading-out manner according to the scale ratio may be implemented in the following technical solution: controlling all layers corresponding to the enlarged state to be reduced for display from a completely opaque state in the fading-out manner according to the scale ratio, all the layers corresponding to the enlarged state being completely transparent when the scale ratio reduces to the minimum endpoint value of the transition scale ratio interval; or controlling a first part of layers corresponding to the enlarged state to be reduced for display from a completely opaque state in the fading-out manner according to the scale ratio, the first part of layers corresponding to the enlarged state being completely transparent when the scale ratio reduces to the minimum endpoint value of the transition scale ratio interval, and the first part of layers corresponding to the enlarged state including: the grid layer, the ground layer, a building in the attachment layer, and the atmosphere layer.

For example, FIG. 7A is a first schematic bar diagram of a relationship between layer transparency and a scale ratio according to an embodiment of this application. In FIG. 7A, a horizontal axis of a coordinate axis corresponds to the scale ratio, a is greater than b, a and b are respectively a number greater than 10 and less than 100, the scale ratio 10% to b % is the scale ratio interval of the global state, the scale ratio b % to a % is the transition scale ratio interval, and a % to 100% is the scale ratio interval of the enlarged state. A vertical axis indicates a hierarchy relationship between layers, and a layer in a direction indicated by the vertical axis has a higher hierarchy. In FIG. 7A, the transparency is indicated by a color depth of bars, a lighter color indicates higher transparency, and a blank part has transparency of 100%.

In the transition scale ratio interval, for the at least a part of layers corresponding to the enlarged state, the transparency of the plot status layer 406A, the ground layer 402A, the grid layer 401A, the attachment layer 403A, and the atmosphere layer 405A is negatively correlated to the scale ratio. In a process that the scale ratio reduces from a % to b %, the transparency of the plot status layer 406A, the ground layer 402A, the grid layer 401A, the attachment layer 403A (not including the obstacle), and the atmosphere layer 405A gradually increases, and when the scale ratio reaches the minimum endpoint value b %, the at least a part of layers corresponding to the enlarged state is completely transparent. FIG. 7B is a second schematic bar diagram of a relationship between layer transparency and a scale ratio according to an embodiment of this application. The enlarged state further corresponds to layers of the command mark 409A and the selection frame control 408A, and in any scale ratio interval, these layers may be displayed at transparency of 0%. The transparency of 0% presents the completely opaque state.

In this embodiment of this application, the transparency of the at least a part of layers corresponding to the enlarged state and the transparency of the at least a part of layers corresponding to the global state are adjusted along with the scale ratio, implementing seamless switching between the enlarged map and the global map, and enhancing the three-dimensional perspective effect of the two-level scalable map.

In some embodiments, the following operations are synchronously performed when the first part of layers corresponding to the enlarged state is controlled to be reduced for display in the fading-out manner according to the scale ratio: controlling a second part of layers corresponding to the enlarged state to be reduced for display according to the scale ratio, the second part of layers corresponding to the enlarged state including: an obstacle in the attachment layer; and maintaining the second part of layers corresponding to the enlarged state to be in a completely opaque state before the scale ratio reduces to an intermediate value, and transforming the second part of layers corresponding to the enlarged state into a completely transparent state in a jumping manner when the scale ratio reduces to the intermediate value, the intermediate value being a non-endpoint value in the transition scale ratio interval.

For example, description is based on the transition scale ratio interval in the foregoing example, and it is assumed that a is 70, and b is 40. The intermediate value is any value between 40 and 70. In this embodiment of this application, for ease of description, a middle value is used as an example for description. The transition scale ratio interval of the scale ratio S meets 70%≥S≥40%, and the intermediate value is 55%. When the scale ratio meets 70%≥S>55%, the obstacle in the attachment layer is displayed at transparency of 0%, and the transparency gradually reduces along with reduction of the scale ratio. When the scale ratio is equal to 55%, the transparency of the obstacle in the attachment layer is 100%, and the obstacle is transformed into a completely transparent state in a jumping manner.

In some embodiments, the controlling at least a part of layers corresponding to the global state to be reduced for display in a fading-in manner according to the scale ratio may be implemented in the following technical solution: controlling all layers corresponding to the global state to be reduced for display from a completely transparent state in the fading-in manner according to the scale ratio, all the layers corresponding to the global state being completely opaque when the scale ratio reduces to the minimum endpoint value of the transition scale ratio interval; or controlling a first part of layers corresponding to the global state to be reduced for display from a completely transparent state in the fading-in manner according to the scale ratio, the first part of layers corresponding to the global state being completely opaque when the scale ratio reduces to the minimum endpoint value of the transition scale ratio interval, and the first part of layers corresponding to the global state including: the global map layer and the global cover layer.

Referring to FIG. 7A, in the transition scale ratio interval, for the at least a part of layers corresponding to the global state, the transparency of the global mist layer 403D and the global map layer 402D is positively correlated to the scale ratio. In a process that the scale ratio reduces from a % to b %, the transparency of the global mist layer 403D and the global map layer 402D gradually reduces. When the scale ratio reduces to the minimum endpoint value b %, the at least a part of layers corresponding to the global state is completely opaque.

In some embodiments, the following operations are synchronously performed when the first part of layers corresponding to the global state is controlled to be reduced for display from a completely transparent state in the fading-in manner according to the scale ratio: controlling a second part of layers corresponding to the global state to be reduced for display according to the scale ratio, the second part of layers corresponding to the global state including: a global map icon layer; and maintaining the second part of layers corresponding to the global state to be in a completely transparent state before the scale ratio reduces to an intermediate value, and transforming the second part of layers corresponding to the global state into a completely opaque state in a jumping manner when the scale ratio reduces to the intermediate value, the intermediate value being a non-endpoint value in the transition scale ratio interval.

For example, description is based on the transition scale ratio interval in the foregoing example, and it is assumed that a is 70, and b is 40. The intermediate value is any value between 40 and 70. In this embodiment of this application, for ease of description, a middle value is used as an example for description. The transition scale ratio interval of the scale ratio S meets 70%≥S≥40%, and the intermediate value is 55%. When the scale ratio meets 70%≥S>55%, the transparency of the global map icon layer maintains 100%. When the scale ratio is equal to 55%, the transparency of the global map icon layer is 0%, and the global map icon layer is transformed into a completely opaque state in a jumping manner.

In some embodiments, the transition scale ratio interval is set between the following two intervals: the scale ratio interval corresponding to the enlarged state and a scale ratio interval corresponding to a global state; and the following operations are performed when the scale ratio corresponding to the scale operation is in the transition scale ratio interval and gradually increases: controlling at least a part of layers corresponding to the global state to be enlarged for display from a completely opaque state in the fading-out manner according to the scale ratio, the at least a part of layers corresponding to the global state being completely transparent when the scale ratio increases to the maximum endpoint value of the transition scale ratio interval; and controlling at least a part of layers corresponding to the enlarged state to be enlarged for display from a completely opaque state in the fading-in manner according to the scale ratio, the at least a part of layers corresponding to the enlarged state being completely opaque when the scale ratio increases to the maximum endpoint value of the transition scale ratio interval.

All the layers corresponding to the enlarged state and all the layers corresponding to the global state have a same initial size.

For example, the at least a part of layers corresponding to the enlarged state may be at least one layer of the grid layer, the ground layer, the buildings in the attachment layer, the atmosphere layer, the building health point, the weather special effect, the command mark, and the selection frame control corresponding to the enlarged state. The at least a part of layers corresponding to the global state may be at least one layer of the global mist layer, the global map layer, and the global map icon layer according to the global state.

For example, it is assumed that the transition scale ratio interval of the scale ratio S is a %≥S≥b %. For example, a is 70, and b is 40. The maximum endpoint value is 70%, and when the scale ratio is 40%, the at least a part of layers corresponding to the enlarged state is completely transparent (the transparency being 100%), and the at least a part of layers corresponding to the global state is completely opaque (the transparency being 0%). When S meets a %≥S≥b %, and the scale ratio gradually increases, the transparency of the at least a part of layers corresponding to the enlarged state reduces, and the transparency of the at least a part of layers corresponding to the global state increases. When the scale ratio is the maximum endpoint value, which is 70%, the at least a part of layers corresponding to the enlarged state is completely opaque (the transparency being 0%), and the at least a part of layers corresponding to the global state is completely transparent (the transparency being 100%).

In this embodiment of this application, the transparency of the at least a part of layers corresponding to the enlarged state and the transparency of the at least a part of layers corresponding to the global state are adjusted along with the scale ratio, implementing seamless switching between the enlarged map and the global map, and enhancing the three-dimensional perspective effect of the two-level scalable map.

In some embodiments, the controlling at least a part of layers corresponding to the global state to be enlarged for display from a completely opaque state in a fading-out manner according to the scale ratio may be implemented in the following technical solution: controlling all the layers corresponding to the global state to be enlarged for display from a completely opaque state in the fading-out manner according to the scale ratio, all the layers corresponding to the global state being completely transparent when the scale ratio increases to the maximum endpoint value of the transition scale ratio interval; or controlling the first part of layers corresponding to the global state to be enlarged for display from a completely opaque state in the fading-out manner according to the scale ratio, the first part of layers corresponding to the global state being completely transparent when the scale ratio increases to the maximum endpoint value of the transition scale ratio interval, and the first part of layers corresponding to the global state including: the global map layer and the global cover layer.

Referring to FIG. 7A, in the transition scale ratio interval, for the at least a part of layers corresponding to the global state, the transparency of the global mist layer 403D and the global map layer 402D is positively correlated to the scale ratio. In a process that the scale ratio increases from b % to a %, the transparency of the global mist layer 403D and the global map layer 402D gradually increases. When the scale ratio increases to the maximum endpoint value a %, the at least a part of layers corresponding to the global state is completely transparent.

In this embodiment of this application, the transparency of the at least a part of layers corresponding to the global state is adjusted along with the scale ratio, forming a fading-in and fading-out display effect, implementing seamless switching between the enlarged map and the global map, and enhancing the three-dimensional perspective effect of the global state map in the two-level scalable map.

In some embodiments, the following operations are synchronously performed when the first part of layers corresponding to the global state is controlled to be enlarged for display from a completely opaque state in the fading-out manner according to the scale ratio: controlling a second part of layers corresponding to the global state to be enlarged for display from a completely opaque state according to the scale ratio, the second part of layers corresponding to the global state including: the global map icon layer; and maintaining the second part of layers corresponding to the global state to be in a completely opaque state before the scale ratio increases to an intermediate value, and transforming the second part of layers corresponding to the global state into a completely transparent state in a jumping manner when the scale ratio increases to the intermediate value, the intermediate value being a non-endpoint value in the transition scale ratio interval.

For example, description is based on the transition scale ratio interval in the foregoing example, and it is assumed that a is 70, and b is 40. The intermediate value is any value between 40 and 70. In this embodiment of this application, for ease of description, a middle value is used as an example for description. The transition scale ratio interval of the scale ratio S meets 70%≥S≥40%, and the intermediate value is 55%. When the scale ratio meets 55%>S≥40%, the transparency of the global map icon layer maintains 0%. When the scale ratio is equal to 55%, the transparency of the global map icon layer is 100%, and the global map icon layer is transformed into a completely transparent state in a jumping manner.

In this embodiment of this application, the transparency of the global map icon layer is adjusted in a jumping manner, so that it is convenient to view different icons included in the global map icon layer in the seamless switching between the enlarged map and the global map, improving convenience for the user to perform a map scale operation, improving the human-machine interactive efficiency, and enhancing the three-dimensional perspective effect of the global state map in the two-level scalable map.

In some embodiments, the controlling at least a part of layers corresponding to the enlarged state to be enlarged for display from a completely opaque state in a fading-in manner according to the scale ratio may be implemented in the following technical solution: controlling all the layers corresponding to the enlarged state to be enlarged for display from a completely opaque state in the fading-in manner according to the scale ratio, all the layers corresponding to the enlarged state being completely opaque when the scale ratio increases to the maximum endpoint value of the transition scale ratio interval; or controlling the first part of layers corresponding to the enlarged state to be enlarged for display from a completely opaque state in the fading-in manner according to the scale ratio, the first part of layers corresponding to the enlarged state being completely opaque when the scale ratio increases to the maximum endpoint value of the transition scale ratio interval, the first part of layers corresponding to the enlarged state including: the grid layer, the ground layer, a building in the attachment layer, and the atmosphere layer.

Referring to FIG. 7A, in the transition scale ratio interval, for the at least a part of layers corresponding to the enlarged state, the transparency of the plot status layer 406A, the ground layer 402A, the grid layer 401A, the attachment layer 403A, and the atmosphere layer 405A is negatively correlated to the scale ratio. In a process that the scale ratio increases from b % to a %, the transparency of the plot status layer 406A, the ground layer 402A, the grid layer 401A, the attachment layer 403A (not including the obstacle), and the atmosphere layer 405A gradually reduces, and when the scale ratio reaches the maximum endpoint value a %, the at least a part of layers corresponding to the enlarged state is completely opaque.

In this embodiment of this application, the transparency of the at least a part of layers corresponding to the enlarged state is adjusted along with the scale ratio, forming a fading-in and fading-out display effect, implementing seamless switching between the enlarged map and the global map, and enhancing the three-dimensional perspective effect of the global state map in the two-level scalable map.

In some embodiments, the following operations are synchronously performed when the first part of layers corresponding to the enlarged state is controlled to be enlarged for display in the fading-in manner according to the scale ratio: maintaining a second part of layers corresponding to the enlarged state to be in a completely transparent state before the scale ratio increases to an intermediate value, the intermediate value being a non-endpoint value in the transition scale ratio interval, and the second part of layers corresponding to the enlarged state including: an obstacle in the attachment layer; and transforming the second part of layers corresponding to the enlarged state into a completely opaque state in a jumping manner when the scale ratio increases to the intermediate value, and controlling the second part of layers corresponding to the enlarged state to be enlarged for display according to the scale ratio.

For example, description is based on the transition scale ratio interval in the foregoing example, and it is assumed that a is 70, and b is 40. The intermediate value is any value between 40 and 70. In this embodiment of this application, for ease of description, a middle value is used as an example for description. The transition scale ratio interval of the scale ratio S meets 70%≥S≥40%, and the intermediate value is 55%. When the scale ratio meets 55%>S≥40%, the obstacle in the attachment layer is displayed at transparency of 100%. When the scale ratio is equal to 55%, the transparency of the obstacle in the attachment layer is 0%, and the obstacle is transformed into a completely opaque state in a jumping manner. When the scale ratio meets 70%≥S>55%, the transparency of the obstacle in the attachment layer maintains 0%, and the obstacle in the attachment layer is enlarged for display along with increase of the scale ratio.

In this embodiment of this application, the transparency of the obstacle in the attachment layer is adjusted in a jumping manner, so that it is convenient to view the obstacle in the attachment layer in the seamless switching between the enlarged map and the global map, avoiding inconvenience of a user operation, improving the human-machine interactive efficiency, and enhancing the three-dimensional perspective effect of the global state map in the two-level scalable map.

In this embodiment of this application, the plane on which the attachment layer is located is maintained to be parallel to the screen, and through the angles between planes on which the map layer and the grid layer are located and the screen, the map in the enlarged state can be presented in the screen of the terminal device with a visual effect that a closer object looks larger, so that the three-dimensional perspective effect is presented. It is unnecessary to set a 3D grid map, a perspective depth effect is implemented based on the materials of the 2D grid map, and resources required for implementing the perspective effect are reduced. Compared with the related art in which a mist material is added to implement a mist effect, this application reuses an original atmosphere layer, reducing resource consumption required for implementing the mist effect. When the map is scaled according to a ratio, switching between the enlarged map and the global map is performed in a manner of displaying the map fading-in or fading-out and adjusting the angles between the planes on which the map layer and the grid layer are located and the screen. This implements the seamless switching between the enlarged map and the global map while maintaining the perspective effect, and improves viewing experience.

The following describes an exemplary application of the method for map interaction of a virtual scene provided in the embodiments of this application in an actual application scene.

In the related art, a 3D map with a real perspective effect may be generated according to grid distribution of a map by using a 3D model as an element. There are two display manners of a 2D grid map: fixing an original painting of a large map and superimposing grids on the map, or generating a map by completely splicing map grid units. However, the 3D map can only support a 3D scene, and a development cost is large, a game type and game host platform hardware conditions also have high limitations. Therefore, a game in which a system is mainly a 2D interface cannot use the 3D map A cost of the 2D map is controllable, but a visual perception effect is poor. The map does not have real perspective, and cannot show vastness of an exploration region.

The mist effect of the 3D map or the 2D map is generally implemented by covering the map with a cloud special effect material. For example, a cloud layer material is used to cover an unexplored region of the map, forming a mist effect outside a field of view A presentation manner of the mist effect in the related art limits visual presentation of the unexplored region. If dynamic mist presentation is required to be implemented, more computing resources need to be consumed to implement random merging of unit mists, an animation mechanism of random dissipation needs to be developed, and realism of the mist effect is in conflict with resource consumption.

The method for map interaction of a virtual scene provided in the embodiments of this application may use 2D materials to construct a two-level scalable grid map, implementing a three-dimensional perspective visual effect, and implements a mist effect on an enlarged map of 2D materials through reverse display. While the three-dimensional perspective effect is satisfied, the method in the embodiments of this application may also implement seamless transition switching in a process of two-level scaling of an ultra-large grid map.

The 2D map is based on the 2D materials. For ease of description, hierarchy of the 2D grid map used in this embodiment of this application is first described below. FIG. 4A is a first schematic diagram of a layer according to an embodiment of this application. The enlarged state map 404A includes: the grid layer 401A, the ground layer 402A above the grid layer 401A, and the attachment layer 403A above the ground layer 402A. Grids corresponding to the grid layer 401A are tiled grids, and each cell (the smallest unit geometric shape in the grid) in the grid has a same size and shape. The ground layer 402A includes a plurality of ground image materials. The ground image material is configured to indicate terrain information such as sand, forest, and wilderness. Each ground image material is in a one-to-one correspondence to the cell in the grid layer 401A, and each ground image material in each cell has a same size with the size of the cell. The attachment layer 403A includes an obstacle (for example, a mountain, a river, and a forest), an interactive building (for example, a main city and a lighthouse), a virtual enemy (for example, a virtual monster), and other image materials, and the image materials are indicated in a physical image form.

FIG. 5A is a first schematic diagram of a map according to an embodiment of this application. A visual effect of the map shown in FIG. 5A may be presented based on the layer in FIG. 4A. The obstacle 501A is a mountain, the buildings 502A separately indicates different buildings, and the cell 503A is the smallest geometric unit of the grid layer 401A. The ground layer 402A is above the grid layer 401A. FIG. 5E is a first schematic diagram of a layer material according to an embodiment of this application. FIG. 5E includes a plurality of different texture ground materials, and different texture ground materials may indicate different terrains and textures. For example, a state of the region in which each plot is located may alternatively be indicated by using a different texture ground material corresponding to the plot in the ground layer. For example, a light-colored texture ground material indicates that the region in which the plot is located is between an unexplored region and an explored region.

For example, the enlarged state map includes a plurality of hierarchies. The grid layer is parallel to the ground layer, and there are angles of a preset angle value between the planes on which the grid layer and the ground layer are located and the screen. The enlarged state map is viewed from the screen, and the grid layer and the ground layer in the map present an inclined visual effect. The image materials (the buildings, the obstacle, and the like) in the attachment layer are distributed on the grids according to grid coordinates, and the plane on which the attachment layer is located always maintains parallel to the screen. The image materials corresponding to the attachment layer present a vertical visual effect relative to the grid layer and the ground layer, presenting a three-dimensional perspective effect that the image materials corresponding to the attachment layer are vertical on the grid layer and the ground layer on the enlarged state canvas. That is, the image materials of the plane corresponding to the attachment layer present a three-dimensional effect relative to the image materials of the grid layer and the ground layer.

FIG. 5B is a second schematic diagram of a map according to an embodiment of this application. The reference line 501B is parallel to the perpendicular line of the edge of the screen displaying the enlarged state map, the reference line 502B is parallel to the planes on which the ground layer and the grid layer are respectively located, and the angle θ is formed between the reference line 502B and the reference line 501B. The angle θ is the angles between the screen and the planes on which the ground layer and the grid layer are located.

For ease of description of relationships respectively between the screen and the planes on which the grid layer, the ground layer, and the attachment layer are located, FIG. 6A is a first side view of planes on which layers are located according to an embodiment of this application. It is assumed that each layer has a corresponding virtual plane. The screen PN is parallel to the attachment layer plane P3, the ground layer plane P2 is parallel to the grid layer plane P1, and there is the angle θ respectively between the ground layer plane P2 and the screen PN and between the grid layer plane P1 and the screen PN.

The plane on which the enlarged state map is located shown in FIG. 5A is parallel to the screen displaying the enlarged state map, a size of the grids in the map is uniform, and the 2D grid map shown in FIG. 5A cannot present a perspective effect. However, in the map shown in FIG. 5B, there are angles between the screen and the planes on which the ground layer and the grid layer are located, so that the distance between the grid on the upper portion of the map and the plane on which the screen is located is farther than the grid on the lower portion of the map and the plane on which the screen is located. Based on the principle of the perspective effect that a closer object looks larger, in the visual effect, the following picture is presented: a grid size on the upper portion of the map is less than a grid size on the lower portion of the map, that is, the three-dimensional perspective effect.

For example, the perspective effect may alternatively be enhanced by adjusting a size of the image material in the attachment layer. For example, the size of the image material in the attachment layer is scaled according to a size of the cell corresponding to the image material in the attachment layer displayed in the screen. When each cell of the grid layer is displayed in the effect that a closer object looks larger in the screen, the image materials in the attachment layer scaled according to the size of the cell also present the effect that a closer object looks larger in the map, enhancing the perspective effect of the 2D grid map.

In this embodiment of this application, by reusing a 2D material of the 2D grid map, the three-dimensional perspective effect is implemented in the 2D grid map. The 2D grid map consumes less resources, when the terminal device runs a client corresponding to the virtual scene, using the 2D grid map in this embodiment of this application can implement the three-dimensional perspective effect and reduce operating internal memory of the client.

For example, while the perspective effect is implemented, realism of the map may alternatively be improved by adding the field of view mist effect to the 2D grid map, to enhance user viewing experience. The region with a visual field in the map is a region explored by the virtual object, and the region without a visual field is a region not explored by the virtual object. The field of view mist is a mist effect displayed in the region not explored by the virtual object controlled by the user.

In some embodiments, the 2D grid map further includes the atmosphere layer, and the atmosphere layer is below the grid layer of the enlarged state map. The image material corresponding to the atmosphere layer may be a default image material designed according to a game theme corresponding to the map. A pattern of the default image material includes, for example, cloud, mountains and rivers, text tiling shading, and deep-color background image. The material corresponding to the atmosphere layer may alternatively be an animation material, for example, an animation of a fish swimming and an animation of clouds moving slowly. An area of the image material in the atmosphere layer is larger than a full-screen interface of the screen. When the user views the map by scrolling the map, the image material in the atmosphere layer moves along with the scrolling operation, forming an effect of asynchronized movement, thereby enhancing viewing experience of the map.

A solution to implementing the mist effect in the related art is to display an additional image material superimposed on the map, indicating that a covered region is an unexplored region by covering the map. A reverse display manner in the embodiments of this application refers to that the atmosphere layer including the mist image material as a bottom layer, the atmosphere layer is covered by upper layers, and for the unexplored region, the layers above the atmosphere layer are hidden to expose the atmosphere layer at the bottom, thereby implementing the field of view mist effect in the unexplored region.

For example, the field of view mist effect may be implemented through the atmosphere layer in a reverse manner. The grid layer, the ground layer, and the attachment layer are not displayed in the unexplored region, the atmosphere layer is displayed in the unexplored region without covering of the upper layers, and a fading-out grid layer between the unexplored region and the explored region indicates a transition effect (for example, transparency of two layers of grids on an outer edge at a joint between the unexplored region and the explored region gradually changes, transparency of each pixel point in the grid is positively correlated to a straight line distance between the pixel point and the explored region, and a larger straight line distance indicates higher transparency, forming a fading-out visual effect), to implement the field of view mist effect.

In this embodiment of this application, instead of covering the enlarged map with a sheet tiled mist image material, the grid layer, the ground layer, and the attachment layer in the region without a visual field are not displayed, and the atmosphere layer at the bottom is displayed reversely, forming the field of view mist effect, which reduces the computing resources consumed for the map of the virtual scene compared with the related art in which a material image is additionally used to cover the map at the top layer for the unexplored region, a plurality of layers of materials are superimposed in the unexplored region, and graphical computing resources are increased.

FIG. 4B is a second schematic diagram of a layer according to an embodiment of this application. The attachment layer 403A, the ground layer 402A, and the grid layer 401A are displayed in the region with a visual field 402B, and the three layers covers the atmosphere layer 405A, so that the atmosphere layer 405A is not displayed in the region with a visual field 402B. The grid layer 401B includes the transition region 403B, the transition region 403B is located between the region with a visual field and the region without a visual field, and the grid layer is displayed in the transition region 403B in the fading-out manner. The atmosphere layer 405A is displayed in the region without a visual field 401B, and the grid layer is displayed in the fading-out manner. The grid layer uses the region with a visual field as a circle of a center, and gradually fades outward. The ground layer is hidden in the region without a visual field, and is only displayed in the region with a visual field.

For example, referring to FIG. 5B, the visual effect of the map shown in FIG. 5B may be presented based on the layer in FIG. 4B. The image material corresponding to the atmosphere layer is displayed in the region without a visual field 401B, the image material of the transition region 403B of the grid layer is displayed in the fading-out manner, and the grid layer and the attachment layer (the obstacle 501A and the buildings 502A) are displayed in the region with a visual field 402B. Referring to FIG. 5E, a bottom picture 501E of the atmosphere layer is a preset shadow picture, and the bottom picture 501E of the atmosphere layer is the image material corresponding to the atmosphere layer displayed in the region without a visual field 401B in FIG. 5B.

For example, the angles between the planes on which the ground layer, the grid layer, and the atmosphere layer are respectively located and the screen are the same, forming an effect of a “canvas”. Referring to FIG. 6A, the atmosphere layer plane P4 on which the atmosphere layer is located is parallel to the grid layer plane P1 and the ground layer plane P2. Further, a reverse mist display manner in the embodiments of this application does not affect the three-dimensional perspective effect, and while the three-dimensional perspective effect is maintained, a field of view mist effect with low resource consumption in the 2D grid map is implemented.

In the embodiments of this application, only 2D materials are used, the three-dimensional perspective effect can be implemented. A reverse mist mechanism saves a logic development cost and a design cost of a mist material required for covering the map with the mist image material, and the mist effect can be implemented by using the image material in the atmosphere layer without the mist material, reducing the graphical computing resources consumed for the map of the virtual scene.

In some embodiments, the enlarged state map further includes the building health point (configured to indicate a health point of an interactive building in the attachment layer), the weather special effect (displaying the weather special effect based on a plot at a center of a field of view), and the plot status layer.

For example, for the weather special effect, when the grid corresponding to the weather special effect is selected, a special weather range is displayed for the grid. The weather special effect includes a plurality of weather types, and the special weather range of each weather type is marked with a different color or pattern. The plot status layer includes a plurality of different plot status image materials, different image materials correspond to different status types, and different status types may overlap each other, that is, one plot may have a plurality of types of plot statuses. Plot status type corresponding to the plot status layer include: challengeable, disabled, invading, invasion target, hidden range, occupied, occupied by ally, and the like. The challengeable state has a highest priority, and the image material corresponding to the challengeable state is displayed above the image materials of other states. FIG. 5F is a second schematic diagram of a layer material according to an embodiment of this application. FIG. 5F lists the patterns of the image materials respectively corresponding to the occupied, the occupied by ally, the challengeable, disabled, the invading, the invasion target, and the hidden range.

The 2D grid map further includes the command mark and the selection frame control. The command mark is configured to indicate a task related to a region corresponding to a grid on which the command mark is located, and the task is published by the virtual object having the command authority, and performed by another virtual object in the same camp reaching the region. The selection frame control is configured to indicate that any cell in the grid is selected.

FIG. 4C is a third schematic diagram of a layer according to an embodiment of this application. The 2D grid map includes, from the bottom layer to the top layer: the atmosphere layer 405A, the grid layer 401A, the ground layer 402A, the plot status layer 406A, the attachment layer 403A, the building health point 407A, the selection frame control 408A, the command mark 409A, and the virtual weather special effect 410A. The virtual weather special effect 410A, the building health point 407A, the attachment layer 403A, the ground layer 402A, and the grid layer 401A belong to the enlarged state map 404A. The command mark 409A and the selection frame control 408A belong to a UI layer (the human-machine interaction layer) corresponding to the map of the virtual scene.

For example, the planes on which the attachment layer, the building health point, the selection frame control, the command mark, and the weather special effect are located are parallel to the screen, and a size of each image material in the layers is positively correlated to a size of the grid on which the image material is located displayed in the screen. When each cell in the grid layer is presented in the effect that a closer object looks larger in the screen, the image material parallel to the screen also forms the visual effect that a closer object looks larger in the screen, enhancing the three-dimensional perspective effect.

For example, the angles are formed between the planes on which the atmosphere layer, the grid layer, the ground layer, and the plot status layer are located and the screen, and angles are also formed between the planes on which the atmosphere layer, the grid layer, the ground layer, and the plot status layer are located and the planes on which the attachment layer, the building health point, the selection frame control, the command mark, and the weather special effect are located, so that the image materials in these hierarchies present a vertical effect relative to the atmosphere layer, the grid layer, the ground layer, and the plot status layer, forming three-dimensional view experience.

FIG. 5D is a fourth schematic diagram of a map according to an embodiment of this application. A visual effect of the map shown in FIG. 5D may be presented based on the layer in FIG. 4C. FIG. 5D is a schematic diagram of the enlarged state map. The enlarged state map includes the region without a visual field 401B (including the grid layer 403 displayed in a fading-out state), the attachment layer 405A (including an enemy virtual monster 502D, the buildings 502A, and the obstacle 501A), the occupied region 503D (marked by using the marking frame corresponding to the “occupied” plot state), the marking control 502C, the chat bar 501C, the interface switching control 503C, the interface closing control 504C, and the selection frame control 408A.

For example, in response to a triggering operation for the marking control 502C, a map marking mode is entered. In response to a marking operation for any grid in the region with a visual field 402B in the map, the command mark 409A is displayed in the grid, and the chat bar 501C is configured for presenting chat messages between users. The interface switching control 503C is configured to switch to another virtual scene interface related to a battle corresponding to the map; and hide the 2D grid map in response to the triggering operation for the interface closing control 504. The selection frame control 408A is configured to indicate that the grid in which the selection frame is located is in the selected state.

In some embodiments, the selection frame control and the building health point are arranged at a position moved by a preset ratio (for example, one third) relative to a center of a corresponding grid, preventing the selection frame control and the building health point from covering the plot in the ground layer in the grid and a status mark of the plot status layer, thereby improving the visual effect of the grid map.

In some embodiments, an atmosphere bottom picture frame is further included above the weather special effect layer. The atmosphere bottom picture frame is configured to indicate a boundary of the map. The atmosphere bottom picture frame covers above the other hierarchies of the map, and a boundary of the atmosphere bottom picture frame is identical to the boundary of the map.

In some embodiments, the 2D grid map further includes a global state map. Switching between the global state map and the enlarged state map may be performed.

For example, the global state map includes a global map layer and a global cover layer. A map material of the map in the global state has a size smaller than the size of a map material of the map in the enlarged state (for example, the map material of the map in the global state is a full map material with a size the same as a size of the screen, but not a map formed by slicing the grid units), and includes less information than the enlarged state map, so that a postprocessing cost of the map material in the global map is low. Therefore, in the global state canvas, the field of view mist in the global state is implemented by covering a global mist material on the global map material.

FIG. 4D is a fourth schematic diagram of a layer according to an embodiment of this application. The global state map 401D includes the global map layer 402D, the global mist layer 403D, and the global map icon layer 404D. The global map layer 402D and the global mist layer 403D form the global state canvas. The global map layer 402D includes the global map material; and the global mist layer 403D includes a global cover layer material. The global map icon layer 404D includes a plurality of different types of global map icon materials. Angles are formed between the planes on which the global map layer and the global cover layer are located and the screen. The planes on which the global map layer and the global cover layer are located are parallel to the plane on which the atmosphere layer is located in the 2D grid map, and are parallel to the planes on which the ground layer, the grid layer, the plot status layer, and the weather special effect are located in the enlarged state map. FIG. 6B is a second side view of planes on which layers are located according to an embodiment of this application. The global mist layer plane P6 is parallel to the global map layer plane P5, and the angle θ is formed between the global mist layer plane P6 and the screen PN.

For example, three types of regions are included in the enlarged state, which are the region with a visual field, the region without a visual field, and an occupied region. In the region with a visual field, the map layer, the grid layer, and the attachment layer (the image material displayed in a physical image form corresponding to the attachment layer, for example, a physical image of the building) are displayed. In the region without a visual field, the atmosphere layer and the grid layer fading-out on the outer edge of the region with a visual field are displayed in combination, forming a reverse mist effect. In the occupied region, the grid layer, the ground layer, the plot status layer (image materials superimposed to indicate a corresponding occupied state), and the attachment layer (an image material corresponding to the occupied region). In the enlarged state, the region with a visual field, the region without a visual field, and the occupied region are indicated in display manners respectively corresponding to the three regions, implementing the mist effect.

For example, the mist effect in the global state map may be implemented in the following manners: The global map layer is displayed in the region with a visual field. A mist image material of the global cover layer is displayed to cover the global map in the region without a visual field, forming the mist effect. In the global state map, the plane on which the global map icon layer is located is parallel to the screen, and icons in the global map icon layer are in a one-to-one correspondence to various types of attachments in the attachment layer. For example, the attachment layer includes the building and the virtual monster that are indicated by a physical image material, and the global map icon layer includes the building and the virtual monster that are indicated by a 2D icon material.

FIG. 5C is a third schematic diagram of a map according to an embodiment of this application. FIG. 5C is a schematic diagram of the global state map displayed in the screen. The global map layer 401D is located below the global cover layer 402D. A part of regions of the global map layer 401D are blocked by the global cover layer 402D. The blocked region is an unexplored region, that is, the region without a visual field. The intermediate region that is of the global map layer 401D and that is not blocked by the global cover layer 402D is a region with a visual field 505C. An outer edge of the image material of the global cover layer 402D may be located in the map material of the global map layer 401D. Therefore, there is a map edge region 506C between an outer edge of the global cover layer 402D and the map material of the global map layer 401D. The global map icon layer 404D includes different types of global map icons, for example, a building icon (corresponding to the building indicated by a physical image in the attachment layer, such as a lighthouse and a main city) and a virtual monster icon (corresponding to the virtual monster indicated by a physical image in the attachment layer).

Functions of the marking control 502C, the interface switching control 503C, the interface closing control 504C, the chat bar 501C, and the selection frame control 408A in the global state map may refer to the foregoing enlarged state map, and are not repeated in detail herein. For example, referring to FIG. 5E, the selection frame control 408A is displayed as an icon corresponding to a first selection frame 503E in the enlarged state map, and is displayed as an icon corresponding to a second selection frame 504E in the global state map.

A two-level scaling process of the enlarged state map and the global state map of the two-level map in the embodiments of this application is described below.

For example, the adjustment of the scale ratio may be implemented in any following manner: dragging an adjustment sliding block of a scale of the map, and performing map scaling according to a ratio corresponding to a current position of the sliding block in the scale; performing map scaling based on the sliding distance of the opposite sliding operation of two fingers (for example, the thumb and the forefinger are slid together on the screen, and the map is reduced; or otherwise, the two fingers are slid apart on the screen, and the map is enlarged); and performing scaling based on the angle of scrolling the wheel of the mouse forward or backward (for example, the wheel is scrolled forward, and the map is enlarged according to a number of steps of scrolling forward; or the wheel is scrolled backward, and the map is reduced according to a number of steps of scrolling backward).

For example, in the process of two-level scaling between the enlarged state map and the global state map, in a scaling interval corresponding to the transitional state, transparency of an enlarged map element and a global map element is adjusted according to a scaling percentage. During transition between the enlarged state map and the global state map, in the transition scale ratio interval, angles between the planes on which the global state canvas and the enlarged state canvas are located and the screen change along with the scale ratio, implementing seamless switching and canvas angle changing.

For example, a two-level large map in the embodiments of this application includes each layer in FIG. 4D. Based on this, a preset coordinate point (for example, a lower left corner of the map) is used as a start (x=0, and y=0, where a horizontal coordinate is marked as x, and a vertical coordinate is marked as y), and information such as a terrain, a building, and an obstacle on each coordinate grid is configured, generating the two-level large map with any number of grids. In a process of scaling, an appearing interval or a disappearing interval of the image materials in different layers is defined according to the scale ratio of the horizontal axis, which can implement seamless switching of the elements on different layers between two-level states.

Referring to a hierarchy sequence of each layer corresponding to FIG. 4D, FIG. 7A and FIG. 7B are a schematic bar diagram of a relationship between layer transparency and a scale ratio according to an embodiment of this application. In FIG. 7A, a horizontal axis of a coordinate axis corresponds to the scale ratio, a is greater than b, a and b are respectively a number greater than 10 and less than 100, the scale ratio 10% to b % is the scale ratio interval of the global state, the scale ratio b % to a % is the transition scale ratio interval, and a % to 100% is the scale ratio interval of the enlarged state. A vertical axis indicates a hierarchy relationship between layers, and a layer in a direction indicated by the vertical axis has a higher hierarchy. In FIG. 7A, the transparency is indicated by a color depth of bars, a lighter color indicates higher transparency, and a blank part has transparency of 100%.

The enlarged state map 404A includes the plot status layer 406A, the ground layer 402A, the grid layer 401A, and the attachment layer 403A. It is assumed that under the scale ratio interval of the enlarged state, the transparency of the plot status layer 406A, the ground layer 402A, the grid layer 401A, the attachment layer 403A, and the atmosphere layer 405A does not change along with the scale ratio, and the transparency of each layer is N %, where N is greater than or equal to 0 and less than or equal to 10. The transparency of the global mist layer 403D and the global map layer 402D in the global state map 401D is 100%, that is, under the scale ratio interval of the enlarged state, the global state map is hidden, and the enlarged state map is displayed.

In the transition scale ratio interval, the plot status layer 406A, the ground layer 402A, the grid layer 401A, the attachment layer 403A, the atmosphere layer 405A, the global map layer 402D, and the global mist layer 403D are displayed or hidden in a fading-in and fading-out manner. In other words, in the transition scale ratio interval, the transparency of these layers changes along with the scale ratio.

The global state map 401D includes the global mist layer 403D and the global map layer 402D. It is assumed that under the scale ratio interval of the global state, the transparency of the global mist layer 403D and the global map layer 402D does not change along with the scale ratio, and the transparency of each layer is N %, where N is greater than or equal to 0 and less than or equal to 10. The transparency of the plot status layer 406A, the ground layer 402A, the grid layer 401A, and the attachment layer 403A in the enlarged state map 404A is 100%, that is, under the scale ratio interval of the enlarged state, the enlarged state map is hidden, and the global state map is displayed.

Transparency change of each layer in the transition scale ratio interval is specifically described below.

For example, referring to FIG. 7A, in the transition scale ratio interval, the transparency of the plot status layer 406A, the ground layer 402A, the grid layer 401A, the attachment layer 403A, and the atmosphere layer 405A is negatively correlated to the scale ratio, and a larger scale ratio indicates lower transparency. The transparency of the global mist layer 403D and the global map layer 402D is positively correlated to the scale ratio, and a larger scale ratio indicates higher transparency, implementing the seamless switching between the enlarged map and the global map.

In some embodiments, in the transition scale ratio interval, transparency of the obstacle in the attachment layer does not change, and transparency of the building changes along with the scale ratio. When the scale ratio is b %, the transparency of the obstacle is 100%. When the scale ratio is greater than b % and less than or equal to a %, the transparency of the obstacle is N %.

In some embodiments, when the scale ratio is b %, the transparency of the atmosphere layer 405A is M %, where M may be a value less than 100 and greater than or equal to 90. When the scale ratio is c % (b>c>10), the transparency of the atmosphere layer 405A is 100%. The transparency of the atmosphere layer 405A is negatively correlated to the scale ratio, and a smaller scale ratio indicates higher transparency.

In some embodiments, referring to FIG. 7B, the command mark 409A and the selection frame control 408A are displayed in the same preset transparency at any scale ratio, for example, the transparency is 0%. When the scale ratio is in a first icon interval 701B, the selection frame control 408A is displayed as a selection frame icon of the global state map. When the scale ratio is in a second icon interval 702B, the scale ratio at a joint between the second icon interval 702B and the first icon interval 701B is 55%, and the selection frame control 408A is displayed as a selection frame icon of the enlarged state map. The building health point 407A and the virtual weather special effect 410A are displayed at a scale ratio ranging from d % to 100 (50+a/2>d>a, and it is assumed that a is 70, in this case, d meets 85>d>70). The global map icon layer 404D is displayed at transparency of 0% in the scale ratio ranging from 10% to 55%.

In some embodiments, an inclined angle corresponding to the two-level map is different in the enlarged state and in the global state. The map material of the two-level map includes the enlarged state map material and the global state map material, and sizes of the two types of maps are the same in a one-to-one correspondence in the process of scaling. In the transition scale ratio interval, in the process that the transparency changes along with the scale ratio, FIG. 6C is a schematic diagram of a linear relationship between an angle and a scale ratio according to an embodiment of this application. It is assumed that b is 40, and a is 70. In the scale ratio interval of the global state, the angles between the planes on which the global map layer and the global cover layer are located and the screen are 70°. In the scale ratio interval of the global state, the angles between the planes on which the global map layer and the global cover layer are located and the screen are 70°. In the scale ratio interval of the enlarged state, the angles between the planes on which the plot status layer, the ground layer, the grid layer, and the atmosphere layer are located and the screen are 40°. In the transition scale ratio interval, an angle between a canvas (the planes on which the global map layer, the global cover layer, the plot status layer, the ground layer, the grid layer, and the atmosphere layer are located) of the two-level map and the screen is negatively correlated to the scale ratio, and a higher scale ratio indicates a smaller angle.

In this embodiment of this application, in the process of map scaling, the inclined angle of the canvas is adjusted, implementing 3D transition of the visual effect, and enhancing the three-dimensional perspective effect of the two-level map.

For example, the change of the angle between the plane on which the map is located and the screen may be understood as that an angle between a virtual lens and the image materials in the virtual scene changes, that is, an angle of the virtual lens of the virtual scene is adjusted. In combination with a gradual change of the transparency of different layers in the 2D grid map, the seamless switching between the global map and the enlarged map is implemented.

For example, the 2D grid map with the three-dimensional perspective effect still maintains a “canvas” effect with three-dimensional perspective in a process of being reduced from the enlarged state to the global state. When the scale ratio reaches a specific scale ratio in the process of scaling, the interactive building in the attachment layer is indicated switched from the physical image material to the 2D icon material, so that switching between the image materials in all layers in the process of map scaling is seamless.

The embodiments of this application reuse the 2D materials in the 2D grid map, and construct a two-level ultra-large grid map with the three-dimensional perspective effect. The two-level ultra-large grid map in the embodiments of this application can implement functions of the field of view mist, the two-level scaling, and the like, can implement the three-dimensional perspective effect without the 3D grid map materials, and consumes less operating internal memory of the game client and can be adapted to more hardware devices compared with the 3D grid map, reducing the graphics computing resources required for the virtual scene.

The following continues to describe an exemplary structure of the apparatus 455 for map interaction of a virtual scene implemented as a software module provided in the embodiments of this application. In some embodiments, as shown in FIG. 2, the software module of the apparatus 455 for map interaction of a virtual scene stored in the memory 450 may include: the scale control module 4551, configured to perform the following operations in response to a scale operation for the virtual scene when a scale ratio corresponding to the scale operation is in a scale ratio interval corresponding to an enlarged state: displaying a grid layer based on first transparency, the grid layer including a plurality of grids; and the map display module 4552, configured to display a ground layer above the grid layer based on second transparency, the ground layer including a ground material of the virtual scene, the map display module 4552 being configured to control a first plane on which an enlarged state canvas is located and a screen to form a first angle the enlarged state canvas including the ground layer and the grid layer; the map display module 4552 being configured to display an attachment layer above the ground layer based on third transparency; and the map display module 4552 being configured to control a second plane on which the attachment layer is located to be parallel to the screen.

In some embodiments, the map display module 4552 is configured to display an atmosphere layer below the grid layer based on fourth transparency, the atmosphere layer, the ground layer, and the grid layer together forming the enlarged state canvas in a synchronously changing manner, the atmosphere layer including at least one of the following materials: a dynamical special effect, a background image including at least one color, and shading formed based on text tiling.

In some embodiments, the grid layer, the ground layer, and the attachment layer are displayed in a region with a visual field of the virtual scene, the region with a visual field being a region that a virtual object once reached in the virtual scene. The map display module 4552 is configured to display the atmosphere layer below the grid layer in the region with a visual field and a region without a visual field based on the fourth transparency, the region without a visual field being a region that the virtual object does not reach in the virtual scene.

In some embodiments, the map display module 4552 is configured to display the atmosphere layer below the grid layer in the transition region in a fading-in manner, and display the attachment layer in a fading-out manner, the transition region being a region for transition from the region with a visual field to the region without a visual field in the virtual scene.

In some embodiments, the map display module 4552 is configured to display a plot status layer between the ground layer and the attachment layer based on fifth transparency, the plot status layer including at least one material, each material being attached to one grid, a material on each grid being configured for indicating a status of a region corresponding to the grid, types of the status including:
occupied, indicating that the region corresponding to the grid is occupied by a home camp;
occupied by ally, indicating that the region corresponding to the grid is occupied by an allied camp of the home camp;
a virtual weather, indicating that the region corresponding to the grid is in the virtual weather;
challengeable, indicating that the region corresponding to the grid is invaded by an enemy camp, and is capable of being seized by the home camp;
invading, indicating that the region corresponding to the grid is invaded by the enemy camp;
an invasion target, indicating that the region corresponding to the grid is the invasion target of the home camp; and
a hidden range, indicating that the region corresponding to the grid is the hidden region.

In some embodiments, the map display module 4552 is configured to display a human-machine interaction layer above the attachment layer, the human-machine interaction layer including at least one material, a region other than the material in the human-machine interaction layer being transparency, and each material being attached to one grid and configured for human-machine interaction based on the grid. Types of the human-machine interaction including:
a virtual weather special effect, configured for presenting a virtual weather of a region corresponding to the grid in which the virtual weather special effect is located; a command mark, configured for presenting a task related to the region corresponding to the grid, the task being published by a virtual object having a command authority;
a building health point, configured for presenting a health point of a building on the grid; and
a selection frame control, configured to indicate that the grid is in a selected state.

In some embodiments, all display life cycles of the materials are the scale ratio interval corresponding to the enlarged state; or a display life cycle of a first part of materials is the scale ratio interval corresponding to the enlarged state, and a display life cycle of a second part of materials is a head sub-interval, the head sub-interval being a sub-interval cut from a head of the scale ratio interval, the first part of materials including: the command mark and the selection frame control; and the second part of materials including the virtual weather special effect and the building health point.

In some embodiments, the transition scale ratio interval is set between the following two intervals: the scale ratio interval corresponding to the enlarged state and a scale ratio interval corresponding to a global state. The map display module 4552 is configured to perform the following operations when the scale ratio corresponding to the scale operation is in the transition scale ratio interval and gradually reduces: controlling the enlarged state canvas and the screen to form the first angle that gradually increases, and forming a second angle between the enlarged state canvas and the screen when the scale ratio reduces to a minimum endpoint value of the transition scale ratio interval; and controlling a global state canvas and the screen to form the first angle that gradually increases, and forming the second angle between the global state canvas and the screen when the scale ratio reduces to the minimum endpoint value of the transition scale ratio interval, the global state canvas including a global map layer and a global cover layer displayed in the global state.

In some embodiments, the transition scale ratio interval is set between the following two intervals: the scale ratio interval corresponding to the enlarged state and a scale ratio interval corresponding to a global state. The map display module 4552 is configured to perform the following operations when the scale ratio corresponding to the scale operation is in the transition scale ratio interval and gradually increases: controlling the enlarged state canvas and the screen to form a second angle that gradually reduces, and forming the first angle between the enlarged state canvas and the screen when the scale ratio increases to a maximum endpoint value of the transition scale ratio interval; and controlling a global state canvas and the screen to form the second angle that gradually reduces, and forming the first angle between the global state canvas and the screen when the scale ratio increases to the maximum endpoint value of the transition scale ratio interval, the global state canvas including a global map layer and a global cover layer displayed in the global state.

In some embodiments, the transition scale ratio interval is set between the following two intervals: the scale ratio interval corresponding to the enlarged state and a scale ratio interval corresponding to a global state. The map display module 4552 is configured to perform the following operations when the scale ratio corresponding to the scale operation is in the transition scale ratio interval and gradually reduces: controlling at least a part of layers corresponding to the enlarged state to be reduced for display in a fading-out manner according to the scale ratio, the at least a part of layers corresponding to the enlarged state being completely transparent when the scale ratio reduces to a minimum endpoint value of the transition scale ratio interval; and controlling at least a part of layers corresponding to the global state to be reduced for display in a fading-in manner according to the scale ratio, the at least a part of layers corresponding to the enlarged state being completely opaque when the scale ratio reduces to the minimum endpoint value of the transition scale ratio interval, all layers corresponding to the enlarged state and all layers corresponding to the global state having a same initial size.

In some embodiments, the map display module 4552 is configured to control all layers corresponding to the enlarged state to be reduced for display from a completely opaque state in the fading-out manner according to the scale ratio, all the layers corresponding to the enlarged state being completely transparent when the scale ratio reduces to the minimum endpoint value of the transition scale ratio interval; or controlling a first part of layers corresponding to the enlarged state to be reduced for display in the fading-out manner according to the scale ratio, the first part of layers corresponding to the enlarged state being completely transparent when the scale ratio reduces to the minimum endpoint value of the transition scale ratio interval, and the first part of layers corresponding to the enlarged state including: the grid layer, the ground layer, a building in the attachment layer, and the atmosphere layer.

In some embodiments, the map display module 4552 is configured to synchronously perform the following operations when the first part of layers corresponding to the enlarged state is controlled to be reduced for display in the fading-out manner according to the scale ratio: controlling a second part of layers corresponding to the enlarged state to be reduced for display according to the scale ratio, the second part of layers corresponding to the enlarged state including: an obstacle in the attachment layer; and maintaining the second part of layers corresponding to the enlarged state to be in a completely opaque state before the scale ratio reduces to an intermediate value, and transforming the second part of layers corresponding to the enlarged state into a completely transparent state in a jumping manner when the scale ratio reduces to the intermediate value, the intermediate value being a non-endpoint value in the transition scale ratio interval.

In some embodiments, the map display module 4552 is configured to control all the layers corresponding to the global state to be reduced for display in the fading-in manner according to the scale ratio, all the layers corresponding to the global state being completely opaque when the scale ratio reduces to the minimum endpoint value of the transition scale ratio interval; or controlling a first part of layers corresponding to the global state to be reduced for display in the fading-in manner according to the scale ratio, the first part of layers corresponding to the global state being completely opaque when the scale ratio reduces to the minimum endpoint value of the transition scale ratio interval, and the first part of layers corresponding to the global state including: the global map layer and the global cover layer.

In some embodiments, the map display module 4552 is configured to synchronously perform the following operations when the first part of layers corresponding to the global state is controlled to be reduced for display in the fading-in manner according to the scale ratio: controlling a second part of layers corresponding to the global state to be reduced for display according to the scale ratio, the second part of layers corresponding to the global state including: the global map icon layer; and maintaining the second part of layers corresponding to the global state to be in a completely transparent state before the scale ratio reduces to an intermediate value, and transforming the second part of layers corresponding to the global state into a completely opaque state in a jumping manner when the scale ratio reduces to the intermediate value, the intermediate value being a non-endpoint value in the transition scale ratio interval.

In some embodiments, the transition scale ratio interval is set between the following two intervals: the scale ratio interval corresponding to the enlarged state and a scale ratio interval corresponding to a global state. The map display module 4552 is configured to perform the following operations when the scale ratio corresponding to the scale operation is in the transition scale ratio interval and gradually increases: controlling at least a part of layers corresponding to the global state to be enlarged for display in the fading-out manner according to the scale ratio, the at least a part of layers corresponding to the global state being completely transparent when the scale ratio increases to a maximum endpoint value of the transition scale ratio interval; and controlling at least a part of layers corresponding to the enlarged state to be enlarged for display in the fading-in manner according to the scale ratio, the at least a part of layers corresponding to the enlarged state being completely opaque when the scale ratio increases to the maximum endpoint value of the transition scale ratio interval, all layers corresponding to the enlarged state and all layers corresponding to the global state having a same initial size.

In some embodiments, the map display module 4552 is configured to control all the layers corresponding to the global state to be enlarged for display in the fading-out manner according to the scale ratio, all the layers corresponding to the global state being completely transparent when the scale ratio increases to the maximum endpoint value of the transition scale ratio interval; or controlling a first part of layers corresponding to the global state to be enlarged for display in the fading-out manner according to the scale ratio, the first part of layers corresponding to the global state being completely transparent when the scale ratio increases to the maximum endpoint value of the transition scale ratio interval, and the first part of layers corresponding to the global state including: the global map layer and the global cover layer.

In some embodiments, the map display module 4552 is configured to synchronously perform the following operations when the first part of layers corresponding to the global state is controlled to be enlarged for display in the fading-out manner according to the scale ratio: controlling a second part of layers corresponding to the global state to be enlarged for display according to the scale ratio, the second part of layers corresponding to the global state including: the global map icon layer; and maintaining the second part of layers corresponding to the global state to be in a completely opaque state before the scale ratio increases to an intermediate value, and transforming the second part of layers corresponding to the global state into a completely transparent state in a jumping manner when the scale ratio increases to the intermediate value, the intermediate value being a non-endpoint value in the transition scale ratio interval.

In some embodiments, the map display module 4552 is configured to control all the layers corresponding to the enlarged state to be enlarged for display in the fading-in manner according to the scale ratio, all the layers corresponding to the enlarged state being completely opaque when the scale ratio increases to the maximum endpoint value of the transition scale ratio interval; or controlling a first part of layers corresponding to the enlarged state to be enlarged for display in the fading-in manner according to the scale ratio, the first part of layers corresponding to the enlarged state being completely opaque when the scale ratio increases to the maximum endpoint value of the transition scale ratio interval, and the first part of layers corresponding to the enlarged state including: the grid layer, the ground layer, a building in the attachment layer, and the atmosphere layer.

In some embodiments, the map display module 4552 is configured to synchronously perform the following operations when the first part of layers corresponding to the enlarged state is controlled to be enlarged for display in the fading-in manner according to the scale ratio: maintaining a second part of layers corresponding to the enlarged state to be in a completely transparent state before the scale ratio increases to an intermediate value, the intermediate value being a non-endpoint value in the transition scale ratio interval, and the second part of layers corresponding to the enlarged state including: an obstacle in the attachment layer; and transforming the second part of layers corresponding to the enlarged state into a completely opaque state in a jumping manner when the scale ratio increases to the intermediate value, and controlling the second part of layers corresponding to the enlarged state to be enlarged for display according to the scale ratio.

In some embodiments, the map display module 4552 is configured to perform the following operations when the scale ratio corresponding to the scale operation is in the scale ratio interval corresponding to the global state: displaying a global map layer based on sixth transparency, the global map layer including a global map of the virtual scene; displaying a global cover layer above the global map layer based on seventh transparency, the global cover layer including a material with a cover effect that is configured to cover a region without a visual field in the global map, and the region without a visual field being a region that a virtual object does not reach in the virtual scene; and controlling a plane on which a global state canvas is located and the screen to form a second angle, the global state canvas including the global map layer and the global cover layer, and the second angle being greater than the first angle.

In some embodiments, the map display module 4552 is configured to display a global map icon layer above the global cover layer, the global map icon layer being configured to replace the attachment layer displayed in the enlarged state, and including an icon corresponding to a material in the attachment layer, and a region other than the icon in the global map icon layer being transparent.

In some embodiments, a manner of the angle value of the first angle being negatively correlated to the scale ratio includes: when a change value of the angle value of the first angle changes, a change value of the scale ratio linearly or non-linearly changes according to an opposite change trend.

The embodiments of this application further provide a computer program product or a computer program. The computer program product or the computer program includes computer instructions, the computer instructions being stored in a non-transitory computer-readable storage medium. A processor of a computer device reads the computer instructions from the computer-readable storage medium, and executes the computer instructions, to cause the computer device to perform the method for map interaction of a virtual scene in the embodiments of this application.

The embodiments of this application provide a non-transitory computer-readable storage medium, having executable instructions stored therein, the executable instructions, when executed by a processor, implementing the method for map interaction of a virtual scene provided in the embodiments of this application, for example, the method for map interaction of a virtual scene shown in FIG. 3A.

In some embodiments, the computer-readable storage medium may be a memory such as an FRAM, a ROM, a PROM, an EPROM, an EEPROM, a flash memory, a magnetic surface memory, an optical disk, or a CD-ROM, or may be any device including one of or any combination of the foregoing memories.

In some embodiments, the executable instructions may be written in any form of programming language (including a compiled or interpreted language, or a declarative or procedural language) by using a form of a program, software, a software module, a script, or code, and may be deployed in any form, including being deployed as an independent program or being deployed as a module, a component, a subroutine, or another unit suitable for use in a computing environment.

In an example, the executable instructions may but do not necessarily, correspond to a file in a file system, and may be stored in a part of a file that saves another program or other data, for example, be stored in one or more scripts in a HyperText Markup Language (HTML) file, stored in a file that is specially used for a program in discussion, or stored in a plurality of collaborative files (for example, be stored in files of one or modules, subprograms, or code parts).

In an example, the executable instructions may be deployed to be executed on a computing device, or deployed to be executed on a plurality of computing devices at the same location, or deployed to be executed on a plurality of computing devices that are distributed in a plurality of locations and interconnected by using a communication network.

In conclusion, in the embodiments of this application, the plane on which the attachment layer is located is maintained to be parallel to the screen, and through the angles between planes on which the map layer and the grid layer are located and the screen, the map in the enlarged state can be presented in the screen of the terminal device with a visual effect that a closer object looks larger, so that the three-dimensional perspective effect is presented. It is unnecessary to set a 3D grid map, a perspective depth effect is implemented based on the materials of the 2D grid map, and resources required for implementing the perspective effect are reduced.

The foregoing descriptions are merely embodiments of this application and are not intended to limit the protection scope of this application. Any modification, equivalent replacement, or improvement made without departing from the spirit and range of this application shall fall within the protection scope of this application. In this application, the term “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A method for adjusting a virtual scene on a screen performed by a terminal device, the method comprising:
receiving a scale operation on a virtual scene, wherein the virtual scene is in a global state;
in accordance with a determination that a scale ratio corresponding to the scale operation is in a scale ratio interval corresponding to an enlarged state:
causing a first angle between the screen and a first plane on which an enlarged state canvas is located, the enlarged state canvas comprising a ground layer and a grid layer, wherein the grid layer including a plurality of grids is displayed grid layer based on first transparency and the ground layer including a ground material of the virtual scene is displayed grid layer based on second transparency; and
displaying an attachment layer above the ground layer on a second plane based on third transparency, wherein the second plane is parallel to the screen.

2. The method according to claim 1, wherein the method further comprises:
displaying an atmosphere layer below the grid layer based on fourth transparency, the atmosphere layer, the ground layer, and the grid layer together forming the enlarged state canvas in a synchronously changing manner in response to the scale operation.

3. The method according to claim 2, wherein the displaying an atmosphere layer below the grid layer based on fourth transparency comprises:
displaying, based on the fourth transparency, the atmosphere layer below the grid layer in a region with a visual field and a region without a visual field, the region with a visual field being a region that a virtual object once reached in the virtual scene and the region without a visual field being a region that the virtual object does not reach in the virtual scene.

4. The method according to claim 1, wherein the method further comprises:
displaying a plot status layer between the ground layer and the attachment layer based on fifth transparency, the plot status layer comprising at least one material, a material on each grid being configured for indicating a status of a region corresponding to the grid.

5. The method according to claim 1, wherein the method further comprises:
displaying a human-machine interaction layer above the attachment layer, the human-machine interaction layer comprising at least one material attached to one grid and configured for human-machine interaction based on the grid.

6. The method according to claim 1, wherein a transition scale ratio interval is set between the scale ratio interval corresponding to the enlarged state and a scale ratio interval corresponding to the global state.

7. The method according to claim 6, wherein the method further comprises:
when the scale ratio corresponding to the scale operation is in the transition scale ratio interval and gradually reduces:
controlling the enlarged state canvas and the screen to form the first angle that gradually increases, and forming a second angle between the enlarged state canvas and the screen when the scale ratio reduces to a minimum endpoint value of the transition scale ratio interval; and
controlling a global state canvas and the screen to form the first angle that gradually increases, and forming the second angle between the global state canvas and the screen when the scale ratio reduces to the minimum endpoint value of the transition scale ratio interval, the global state canvas comprising a global map layer and a global cover layer displayed in the global state.

8. The method according to claim 6, wherein the method further comprises:
when the scale ratio corresponding to the scale operation is in the transition scale ratio interval and gradually increases:
controlling the enlarged state canvas and the screen to form a second angle that gradually reduces, and forming the first angle between the enlarged state canvas and the screen when the scale ratio increases to a maximum endpoint value of the transition scale ratio interval; and
controlling a global state canvas and the screen to form the second angle that gradually reduces, and forming the first angle between the global state canvas and the screen when the scale ratio increases to the maximum endpoint value of the transition scale ratio interval, the global state canvas comprising a global map layer and a global cover layer displayed in the global state.

9. The method according to claim 6, wherein the method further comprises:
when the scale ratio corresponding to the scale operation is in the transition scale ratio interval and gradually reduces:
controlling at least a part of layers corresponding to the enlarged state to be reduced for display in a fading-out manner according to the scale ratio, the at least a part of layers corresponding to the enlarged state being completely transparent in a case that the scale ratio reduces to a minimum endpoint value of the transition scale ratio interval; and
controlling at least a part of layers corresponding to the global state to be reduced for display in a fading-in manner according to the scale ratio, the at least a part of layers corresponding to the enlarged state being completely opaque in a case that the scale ratio reduces to the minimum endpoint value of the transition scale ratio interval,
all layers corresponding to the enlarged state and all layers corresponding to the global state having a same initial size.

10. The method according to claim 1, wherein the method further comprises:
when the scale ratio corresponding to the scale operation is in a scale ratio interval corresponding to the global state:
causing a second angle between the screen and a second plane on which a global state canvas is located, the global state canvas comprising a global map layer displayed based on sixth transparency and a global cover layer displayed above the global map layer based on seventh transparency, and the second angle being greater than the first angle.

11. The method according to claim 10, wherein the method further comprises:
displaying a global map icon layer above the global cover layer, the global map icon layer being configured to replace the attachment layer displayed in the enlarged state, and comprising an icon corresponding to a material in the attachment layer, and a region other than the icon in the global map icon layer being transparent.

12. An electronic device, comprising:
a memory, configured to store executable instructions; and
a processor, configured to implement, when executing the executable instructions stored in the memory, a method for adjusting a virtual scene on a screen including:
receiving a scale operation on a virtual scene, wherein the virtual scene is in a global state;
in accordance with a determination that a scale ratio corresponding to the scale operation is in a scale ratio interval corresponding to an enlarged state:
causing a first angle between the screen and a first plane on which an enlarged state canvas is located, the enlarged state canvas comprising a ground layer and a grid layer, wherein the grid layer including a plurality of grids is displayed grid layer based on first transparency and the ground layer including a ground material of the virtual scene is displayed grid layer based on second transparency; and
displaying an attachment layer above the ground layer on a second plane based on third transparency, wherein the second plane is parallel to the screen.

13. The electronic device according to claim 12, wherein the method further comprises:
displaying an atmosphere layer below the grid layer based on fourth transparency, the atmosphere layer, the ground layer, and the grid layer together forming the enlarged state canvas in a synchronously changing manner in response to the scale operation.

14. The electronic device according to claim 13, wherein the displaying an atmosphere layer below the grid layer based on fourth transparency comprises:
displaying, based on the fourth transparency, the atmosphere layer below the grid layer in a region with a visual field and a region without a visual field, the region with a visual field being a region that a virtual object once reached in the virtual scene and the region without a visual field being a region that the virtual object does not reach in the virtual scene.

15. The electronic device according to claim 12, wherein the method further comprises:
displaying a plot status layer between the ground layer and the attachment layer based on fifth transparency, the plot status layer comprising at least one material, a material on each grid being configured for indicating a status of a region corresponding to the grid.

16. The electronic device according to claim 12, wherein the method further comprises:
displaying a human-machine interaction layer above the attachment layer, the human-machine interaction layer comprising at least one material attached to one grid and configured for human-machine interaction based on the grid.

17. The electronic device according to claim 12, wherein a transition scale ratio interval is set between the scale ratio interval corresponding to the enlarged state and a scale ratio interval corresponding to the global state.

18. The electronic device according to claim 17, wherein the method further comprises:
when the scale ratio corresponding to the scale operation is in the transition scale ratio interval and gradually reduces:
controlling the enlarged state canvas and the screen to form the first angle that gradually increases, and forming a second angle between the enlarged state canvas and the screen when the scale ratio reduces to a minimum endpoint value of the transition scale ratio interval; and
controlling a global state canvas and the screen to form the first angle that gradually increases, and forming the second angle between the global state canvas and the screen when the scale ratio reduces to the minimum endpoint value of the transition scale ratio interval, the global state canvas comprising a global map layer and a global cover layer displayed in the global state.

19. The electronic device according to claim 17, wherein the method further comprises:
when the scale ratio corresponding to the scale operation is in the transition scale ratio interval and gradually increases:
controlling the enlarged state canvas and the screen to form a second angle that gradually reduces, and forming the first angle between the enlarged state canvas and the screen when the scale ratio increases to a maximum endpoint value of the transition scale ratio interval; and
controlling a global state canvas and the screen to form the second angle that gradually reduces, and forming the first angle between the global state canvas and the screen when the scale ratio increases to the maximum endpoint value of the transition scale ratio interval, the global state canvas comprising a global map layer and a global cover layer displayed in the global state.

20. A non-transitory computer-readable storage medium, storing executable instructions, the executable instructions, when executed by a processor of an electronic device, causing the electronic device to implement a method for adjusting a virtual scene on a screen including:
receiving a scale operation on a virtual scene, wherein the virtual scene is in a global state;
in accordance with a determination that a scale ratio corresponding to the scale operation is in a scale ratio interval corresponding to an enlarged state:
causing a first angle between the screen and a first plane on which an enlarged state canvas is located, the enlarged state canvas comprising a ground layer and a grid layer, wherein the grid layer including a plurality of grids is displayed grid layer based on first transparency and the ground layer including a ground material of the virtual scene is displayed grid layer based on second transparency; and
displaying an attachment layer above the ground layer on a second plane based on third transparency, wherein the second plane is parallel to the screen.
